(19) United States
(12) Patent Application Publication
(10) Pub. No.: US 2025/0380283 A1
(43) Pub. Date: Dec. 11, 2025

(54) INCREASED SIDELINK TRANSMISSION CAPACITY

(71) Applicant: QUALCOMM Incorporated, San Diego, CA (US)

(72) Inventors: Shijun WU, San Diego, CA (US); Kapil GULATI, Belle Mead, NJ (US); Huilin XU, Temecula, CA (US)

(21) Appl. No.: 18/740,373

(22) Filed: Jun. 11, 2024

(51) Int. Cl. H04W 72/40; H04L 1/1812; H04W 72/12; H04W 72/25

(52) U.S. Cl. CPC H04W 72/40; H04L 1/1812; H04W 72/12; H04W 72/25

(57) ABSTRACT

Increased sidelink transmission capacity is described. An apparatus is configured to identify a number of TBs to be transmitted, to a SL UE, during a period of a grant associated with a set of transmission occasions. The apparatus is configured to receive, from a network node, a PSSCH configuration indicative of the grant associated with the set of transmission occasions for one or more TBs over a set of resources of the PSSCH during the period of the grant. The apparatus is configured to transmit, via the PSSCH for the SL UE, the one or more TBs during the period of the grant in accordance with the PSSCH configuration.

### TECHNICAL FIELD

The present disclosure relates generally to communication systems, and more particularly, to wireless systems utilizing sidelink (SL) communications.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be or may comprise, and the method may be performed by or at, a user equipment (UE). The apparatus is configured to identify a number of transport blocks (TBs) to be transmitted, to a SL UE, during a period of a grant associated with a set of transmission occasions. The apparatus is configured to receive, from a network node, a physical sidelink shared channel (PSSCH) configuration indicative of the grant associated with the set of transmission occasions for one or more TBs over a set of resources of the PSSCH during the period of the grant. The apparatus is configured to transmit, via the PSSCH for the SL UE, the one or more TBs during the period of the grant in accordance with the PSSCH configuration.

In the aspect, the method includes identifying a number of TBs to be transmitted, to a SL UE, during a period of a grant associated with a set of transmission occasions. The method includes receiving, from a network node, a PSSCH configuration indicative of the grant associated with the set of transmission occasions for one or more TBs over a set of resources of the PSSCH during the period of the grant. The method includes transmitting, via the PSSCH for the SL UE, the one or more TBs during the period of the grant in accordance with the PSSCH configuration.

In the aspect, the computer-readable medium stores computer executable code, the code when executed by at least one processor causes the at least one processor to identify a number of TBs to be transmitted, to a SL UE, during a period of a grant associated with a set of transmission occasions. The code when executed by at least one processor causes the at least one processor to receive, from a network node, a PSSCH configuration indicative of the grant associated with the set of transmission occasions for one or more TBs over a set of resources of the PSSCH during the period of the grant. The code when executed by at least one processor causes the at least one processor to transmit, via the PSSCH for the SL UE, the one or more TBs during the period of the grant in accordance with the PSSCH configuration.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example extended reality (XR) traffic and an example XR traffic flow.

FIG. 5 is a call flow diagram for wireless communications, in accordance with various aspects of the present disclosure.

FIG. 6 is a diagram illustrating example CG configurations for increased SL transmission capacity, in accordance with various aspects of the present disclosure.

FIG. 7 is a diagram illustrating example CG resources for increased SL transmission capacity, in accordance with various aspects of the present disclosure.

FIG. 8 is a diagram illustrating example configurations for hybrid automatic repeat request (HARQ) feedback, in accordance with various aspects of the present disclosure.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Wireless communication networks may be designed to support communications between network nodes (e.g., base stations, gNBs, etc.)/network entities (e.g., in a core network) and UEs, as well as between UEs through SL communications. For instance, a SL transmitter (Tx) UE may transmit signals to a SL receiver (Rx) UE via SL communications, such as for vehicle to everything (V2X) communications. In V2X communications, communication capacity was not the main system design metric, given the relatively small payload, such as for basic safety applications utilizing a few hundred bytes for payloads being transmitted with a period greater than 100 ms. Even advanced NR V2X use cases (e.g., sensor sharing) do not utilize substantial payload capacity increases (e.g., approximately 10 times that of basic safety applications for V2X). Future use cases in V2X may utilize substantial capacity increases. One of the use cases may be sensor sharing, such as raw sensor data (e.g., live video frames, light detection and ranging (LIDAR) images, etc.), which may be sent from vehicle to a cloud platform for processing. An option for such sharing is to send the sensor data to a roadside unit (RSU), as part of roadway infrastructure, which may send the collected sensor data to the network/cloud. Another use case may be for remote driving in which sensor data (e.g., a live video frame) may be sent from a vehicle to the cloud (e.g., to a remote driving control center) via an RSU in real time. In these use cases, a very large SL capacity may be needed (e.g., for a 1080 p video frame with 10-bit color depth and 1% compression). Another future use case may be for XR over SL in which video frames captured by XR on-board cameras may be sent to a UE, such as a smartphone, over SL communications for computation purposes. Mode 1 SL communications may be utilized in these new SL use cases where a network node/entity may allocate resources for SL transmissions, which may more suitable for high throughout traffic (e.g., as interference in Mode 2, or UE autonomous resource allocation, may significantly inhibit system performance).

However, current solutions lack options for such high throughout traffic in SL communications. NR SL Mode 1 resource allocation may support configured grant (CG) implementations for reduced scheduling latency. For instance, with reference to CGs, a UE may send a message with UE assistance information (UAI) to a network node (e.g., a base station, a gNB, etc.) indicating characteristics about the expected SL traffic for the UE, and the network node may then configure a CG to the UE for transmission of the SL traffic. The CG may be configured using parameters such as a CG index, time-frequency resource allocation (e.g., for a slot(s) and a subchannel(s)), and a periodicity of the allocated resources, where the UE may be configured for a maximum of three SL resources in each CG period. The UE may decide how to use the SL resources of the assigned CG, but current solutions provide that the UE transmits a maximum of up to one new TB in each CG period, where resources configured by a CG can also be used for retransmission (e.g., of a new TB transmitted in the current or a previous CG period). A UE may be configured for multiple CGs, but transmission and retransmission of a given TB cannot use resources outside of those configured by a single CG (and on SL, a Tx UE configured with a CG may indicate the CG resource configuration using SL control 1 (SCI-1)). Sensor data transmission over SL, e.g., video frames, may utilize mostly large, yet varying, bandwidth between a SL Tx UE and SL Rx UE, and a very small over-the-air latency, and CG-based PSSCH (CG PSSCH) may be used for resource allocation for high-capacity traffic over SL with reduced scheduling latency. Yet, existing CG-PSSCH solutions do not allow for a meeting of the high-capacity SL transmissions noted herein. Thus, current solutions lack options for such high throughout traffic in SL communications.

Various aspects relate generally to wireless systems utilizing SL communications. Some aspects more specifically relate to increased SL transmission capacity. In some examples, a SL Tx UE may identify a number of TBs to be transmitted, to a SL UE, during a period of a grant associated with a set of transmission occasions. The SL Tx UE may receive, from a network node, a PSSCH configuration indicative of the grant associated with the set of transmission occasions for one or more (e.g., multiple) TBs over a set of resources of the PSSCH during the period of the grant. The SL Tx UE may select at least one resource of the set of resources for the transmission of the one or more TBs, e.g., in accordance with the PSSCH configuration. The SL Tx UE may transmit, via the PSSCH for the SL UE, the one or more TBs during the period of the grant in accordance with the PSSCH configuration.

Particular aspects of the subject matter described in this disclosure can be implemented to realize one or more of the following potential advantages. In some examples, by utilizing CG PSSCH with multiple transmission occasions (TOs) for multiple TBs within a CG period, the described techniques can be used to enable high-capacity traffic over SL. In some examples, by utilizing resource options in a CG PSSCH with multiple TOs for multiple TBs within a CG period, the described techniques can be used to enable flexibility in resource selection and utilization by a SL Tx UE. In some examples, by indicating physical uplink control channel (PUCCH) resources in a CG PSSCH with multiple TOs for multiple TBs within a CG period, the described techniques can be used to enable HARQ feedback for SL transmissions with multiple TOs for multiple TBs within a CG period.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an clement, or any portion of an clement, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

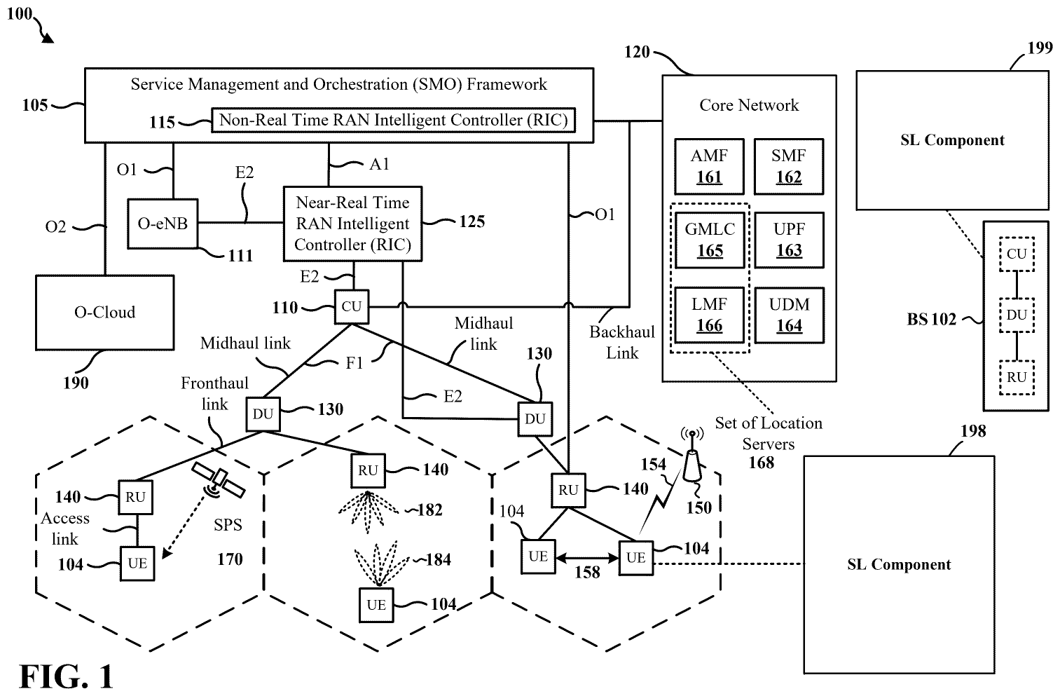

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an Fl interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an AI interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as AI policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-FiTM (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a SL component 198 (“component 198”) that may be configured to identify a number of TBs to be transmitted, to a SL UE, during a period of a grant associated with a set of transmission occasions. The component 198 may be configured to receive, from a network node, a PSSCH configuration indicative of the grant associated with the set of transmission occasions for one or more TBs over a set of resources of the PSSCH during the period of the grant. The component 198 may be configured to transmit, via the PSSCH for the SL UE, the one or more TBs during the period of the grant in accordance with the PSSCH configuration. The component 198 may be configured to transmit, for the network node and prior to the reception of the PSSCH configuration, at least one of a capability of the UE or a configuration indication associated with transmissions of TBs, where the PSSCH configuration is associated with at least one of the capability of the UE or the configuration indication associated with the transmissions of TBs. The component 198 may be configured to receive, from the SL UE via a physical sidelink feedback channel (PSFCH), HARQ feedback associated with the one or more TBs. The component 198 may be configured to transmit, to the network node via the set of PUCCH resources, an indication of the HARQ feedback associated with the one or more TBs. In certain aspects, the base station 102 may have a SL component 199 (“component 199”) that may be configured to configure a UE with a PSSCH configuration indicative of the grant associated with the set of transmission occasions for one or more TBs over a set of resources of the PSSCH during the period of the grant. The component 199 may be configured to receive, from the UE and prior to the reception of the PSSCH configuration, at least one of a capability of the UE or a configuration indication associated with transmissions of TBs, where the PSSCH configuration is associated with at least one of the capability of the UE or the configuration indication associated with the transmissions of TBs. The component 199 may be configured to receive, from the UE via the set of PUCCH resources, an indication of the HARQ feedback associated with the one or more TBs. Accordingly, aspects for increased SL transmission capacity enable high-capacity traffic over SL by utilizing CG PSSCH with multiple TOs for one or more TBs within a CG period with flexibility in resource selection/utilization by a SL Tx UE and HARQ feedback for SL transmissions with multiple TOs for one or more TBs within a CG period via PUCCH resources indications in a CG PSSCH.

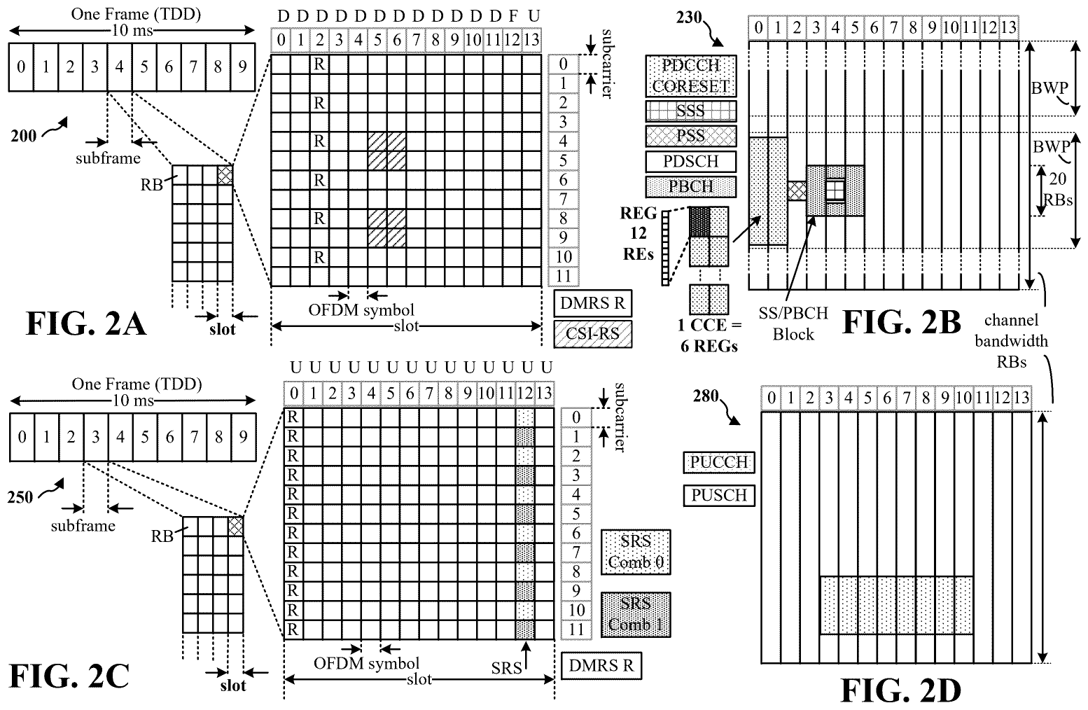

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2μ · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

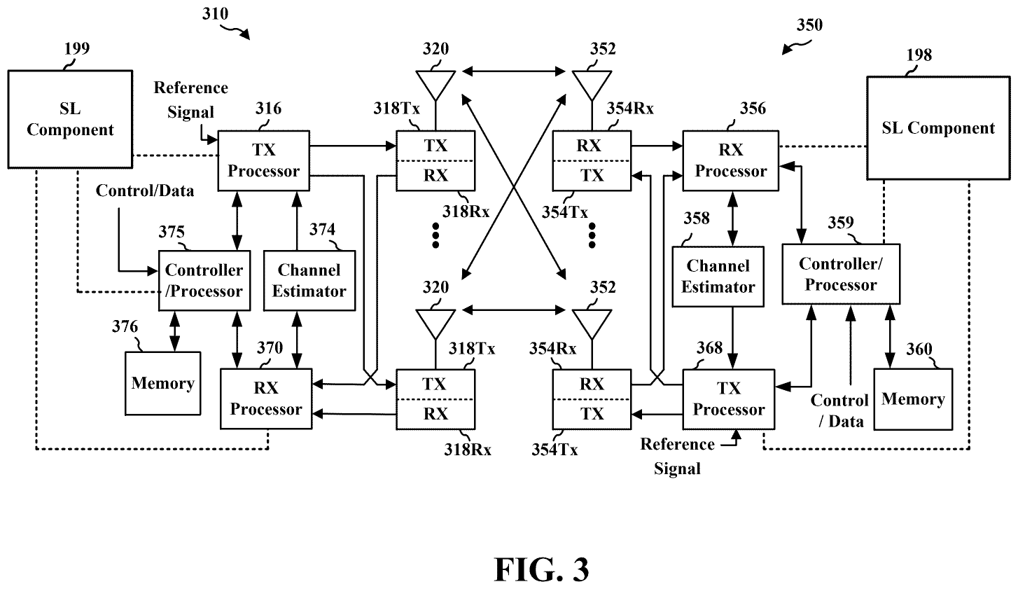

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

A SL Tx UE may transmit signals to a SL receiver Rx UE via SL communications, such as for V2X communications. In V2X communications, communication capacity was not the main system design metric, given the relatively small payload, such as for basic safety applications utilizing a few hundred bytes for payloads being transmitted with a period greater than 100 ms. Even advanced NR V2X use cases (e.g., sensor sharing) do not utilize substantial payload capacity increases (e.g., approximately 10 times that of basic safety applications for V2X). Future use cases in V2X may utilize substantial capacity increases. One of the use cases may be sensor sharing, such as raw sensor data (e.g., live video frames, LIDAR images, etc.), which may be sent from vehicle to a cloud platform for processing. An option for such sharing is to send the sensor data to an RSU, as part of roadway infrastructure, which may send the collected sensor data to the network/cloud. Another use case may be for remote driving in which sensor data (e.g., a live video frame) may be sent from a vehicle to the cloud (e.g., to a remote driving control center) via an RSU in real time. In these use cases, a very large SL capacity may be needed (e.g., for a 1080 p video frame with 10-bit color depth and 1% compression). Another future use case may be for XR over SL in which video frames captured by XR on-board cameras may be sent to a UE, such as a smartphone, over SL communications for computation purposes. Mode 1 SL communications may be utilized in these new SL use cases where a network node/entity may allocate resources for SL transmissions, which may more suitable for high throughout traffic (e.g., as interference in Mode 2, or UE autonomous resource allocation, may significantly inhibit system performance). However, current solutions lack options for such high throughout traffic in SL communications. NR SL Mode 1 resource allocation may support CG implementations for reduced scheduling latency. For instance, with reference to CGs, a UE may send a message with UAI to a network node (e.g., a base station, a gNB, etc.) indicating characteristics about the expected SL traffic for the UE, and the network node may then configure a CG to the UE for transmission of the SL traffic. The CG may be configured using parameters such as a CG index, time-frequency resource allocation (e.g., for a slot(s) and a subchannel(s)), and a periodicity of the allocated resources, where the UE may be configured for a maximum of three SL resources in each CG period. The UE may decide how to use the SL resources of the assigned CG, but current solutions provide that the UE transmits a maximum of up to one new TB in each CG period, where resources configured by a CG can also be used for retransmission (e.g., of a new TB transmitted in the current or a previous CG period). A UE may be configured for multiple CGs, but transmission and retransmission of a given TB cannot use resources outside of those configured by a single CG (and on SL, a Tx UE configured with a CG may indicate the CG resource configuration using SCI-1). Sensor data transmission over SL, e.g., video frames, may utilize mostly large, yet varying, bandwidth between a SL Tx UE and SL Rx UE, and a very small over-the-air latency, and a CG PSSCH may be used for resource allocation for high-capacity traffic over SL with reduced scheduling latency. Yet, existing CG-PSSCH solutions do not allow for a meeting of the high-capacity SL transmissions noted herein. Thus, current solutions lack options for such high throughout traffic in SL communications.

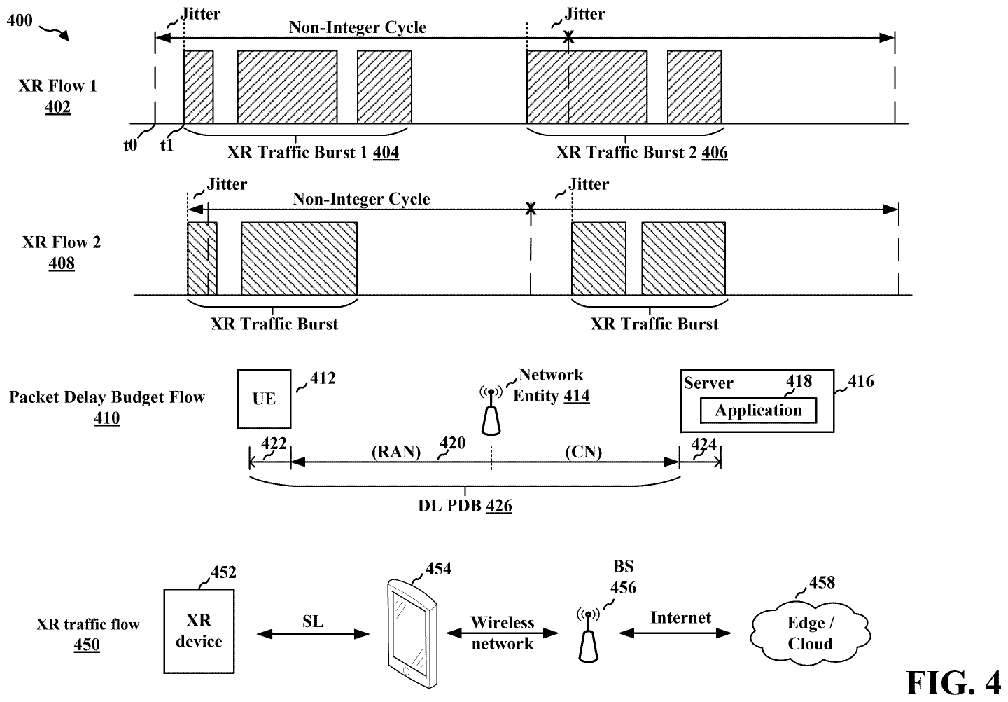

FIG. 4 is a diagram 400 illustrating example extended reality (XR) traffic and an example XR traffic flow. XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset, a multi-projected environment that generates realistic images, sounds, and other sensations that simulate a user's physical presence in a virtual environment, and/or the like. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

XR traffic may arrive in periodic traffic bursts (“XR traffic bursts”). An XR traffic burst may vary in a number of packets per burst and/or a size of each pack in the burst. The diagram 400 illustrates a first XR flow 402 that includes a first XR traffic burst 404 and a second XR traffic burst 406. As illustrated in the diagram 400, the traffic bursts may include different numbers of packets, e.g., the first XR traffic burst 404 being shown with three packets (represented as rectangles in the diagram 400) and the second XR traffic burst 406 being shown with two packets. Furthermore, as illustrated in the diagram 400, the three packets in the first XR traffic burst 404 and the two packets in the second XR traffic burst 406 may vary in size, that is, packets within the first XR traffic burst 404 and the second XR traffic burst 406 may include varying amounts of data.

XR traffic bursts may arrive at non-integer periods (i.e., in a non-integer cycle). The periods may be different than an integer number of symbols, slots, etc. In an example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 402, a UE may expect a first packet of the first XR traffic burst 404 to arrive at time to, but the first packet of the first XR traffic burst 404 arrives at a time t1, as shown.

XR traffic may include multiple flows that arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In an example, the first XR flow 402 may include video data and the second XR flow 408 may include audio data for the video data. In another example, the first XR flow 402 may include intra-coded picture frames (I-frames) that include complete images and the second XR flow 408 may include predicted picture frames (P-frames) that include changes from a previous image.

As noted herein, XR traffic may have an associated e2e PDB. If a packet does not arrive within the e2e PDB, a UE (or a base station) may discard the packet. In an example, if a packet corresponding to a video frame of a video does not arrive at a UE within an e2e PDB, the UE may discard the packet, as the video has advanced beyond the frame.

An XR traffic overall PDB may include a portion to allow for communication delay of data (e2e PDB) between a UE and a computing device, e.g., a server, hosting an application, e.g., for XR, and a portion for additional time after the communication delay before the data is discarded, e.g., residual delay (e.g., RDB). For instance, the diagram 400 includes a packet delay budget flow 410. Packet delay budget flow 410 illustrates a UE 412, a network entity 414 (e.g., a base station or portion thereof), and a server 416 that hosts an application 418. In the illustrated aspect, a communication delay 420 is shown as including a RAN portion between the UE 412 and the network entity 414, as well as a CN portion between the network entity 414 and the server 416. The communication delay 420 may apply to both UL and DL communications. Additionally, a residual delay 422 is shown at the UE 412 for DL communications and a residual delay 424 is shown at the server 416 for UL communications. The communication delay 420 and the residual delay 422 may make up an overall PDB for DL XR communications, e.g., DL PDB 426. Likewise, the communication delay 420 and the residual delay 424 may make up an overall PDB for UL XR communications (not shown for illustrative clarity).

In general, XR traffic may be characterized by relatively high data rates and low latency. The latency in XR traffic may affect the user experience. For instance, XR traffic may have applications in eMBB and URLLC services.

An example of an XR traffic flow 450 is also shown in the context of an XR implementation between an XR device 452 (e.g., a SL Rx UE) and a companion UE 454 (e.g., a smartphone as a SL Tx UE), where the companion UE 454 communicates over a wireless network with a network node (e.g., a base station 456, a gNB, etc.). The base station 456 may communicate with an edge/cloud server 458 that hosts an XR application with which the XR device 452 may be associated.

Aspects herein extend the multi-start and length indicator value (multi-SLIV) grants to CG-PSSCH implementations. Multi-PDSCH/PUSCH single DCI (dynamic grants) has been adapted to Rel 17, and XR is considering multi-SLIV CG and SPS for Rel 18.

Aspects herein for increased SL transmission capacity provide solutions to the issues noted above. Aspects enable high-capacity traffic over SL by utilizing CG PSSCH with multiple TOs for multiple TBs within a CG period. Aspects enable flexibility in resource selection and utilization by a SL Tx UE by utilizing resource options in a CG PSSCH with multiple TOs for multiple TBs within a CG period. Aspects also enable HARQ feedback for SL transmissions with multiple TOs for multiple TBs within a CG period by indicating PUCCH resources in a CG PSSCH with multiple TOs for multiple TBs within a CG period. In aspects, transmissions with multiple TOs for multiple TBs may be associated with XR communications, e.g., video communications, for an XR application.

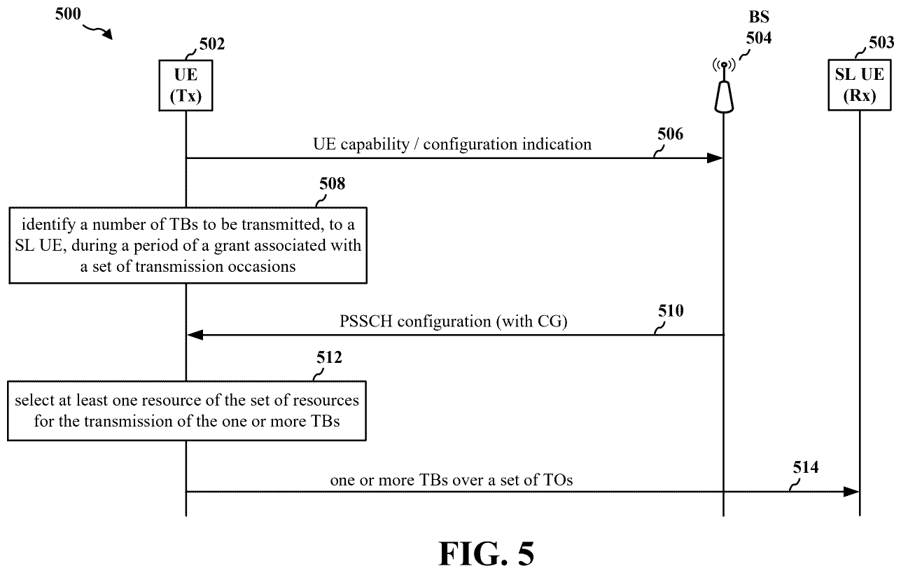

FIG. 5 is a call flow diagram 500 for wireless communications, in various aspects. Call flow diagram 500 illustrates aspects for increased SL transmission capacity for a UE 502 (e.g., a SL Tx UE) that communicates with a SL UE 503 (e.g., an XR device and/or a SL Rx UE) via various forms of SL communications, as well as with a wireless network with one or more network nodes (e.g., a base station 504, such as a gNB or other type of base station or a DU(s), by way of example, as shown and described herein), in various aspects. Aspects described for the UE 502 and/or the SL UE 503, and for XR devices/UEs herein, generally, may be performed may be performed by the UE 502 and/or the SL UE 503 autonomously, in addition to, and/or in lieu of, the other of the UE 502 and/or the SL UE 503. In aspects described herein, an XR device, such as the SL UE 503, in various aspect, may be or may include one or more components as described herein for a UE such as the UE 104 in FIG. 1 and/or the UE 350 in FIG. 3. Additionally, or alternatively, operations for increased SL transmission capacity may be performed by the UE 502 autonomously in addition to, or in lieu of, configurations provided to from the base station 504.

In the illustrated aspects, the UE 502 may be configured to transmit/provide, and the base station 504, may be configured to receive, a UE capability/configuration indication 506. The UE capability/configuration indication 506 may include at least one of a capability of the UE and/or a configuration indication associated with transmissions of TBs, e.g., by the UE 502. The transmission/provision of the UE capability/configuration indication 506 may occur prior to the reception of PSSCH configuration, as described herein, e.g., for a PSSCH configuration 510. In aspects, a configuration indication of the UE capability/configuration indication 506 may include at least one of a traffic type or a traffic characteristic associated with SL communications. At least one of the traffic type or the traffic characteristic may be indicative of transmissions for multiple transmission occasions for one or more/multiple TBs (e.g., one or more TBs 514). In some aspects, the configuration indication may include a request for a PSSCH configuration, as described herein. In aspects, the capability of the UE 502 for the UE capability/configuration indication 506 may be indicative of UE support, e.g., of the UE 502, for transmissions for multiple transmission occasions for the one or more/multiple TBs (e.g., multiple TBs 514), e.g., within a CG PSSCH period, such as with multiple TOs for the one or more TBs 514 within a CG PSSCH period, as described herein). In aspects, to transmit the capability of the UE 502 for the UE capability/configuration indication 506, the UE 502 may be configured to transmit the capability of the UE 502 for the UE capability/configuration indication 506 via at least one of a RRC message, a medium access control (MAC) control element (MAC-CE), a SL buffer status report (BSR), or UAI.

The UE 502 may be configured to identify (at 508) a number of TBs to be transmitted, to the SL UE 503, during a period of a grant associated with a set of transmission occasions. In aspects, the UE 502 may identify (at 508) the number of TBs to be transmitted during the period of the grant associated with the set of transmission occasions prior or subsequent to transmitting the UE capability/configuration indication 506 to the base station 504. In aspects, the number of TBs to be transmitted to the SL UE 503 during a period of a grant may be identified (at 508) based on desired video communications for an XR application associated with at least one of the UE 502 and/or the SL UE 503.

The PSSCH configuration 510 may be associated with at least one of the capability of the UE 502 and/or the configuration indication associated with the transmissions of TBs, in aspects. The UE 502 may be configured to receive, and the base station 504 may be configured to transmit/provide, the PSSCH configuration 510. The PSSCH configuration 510 may be indicative of the grant associated with the set of transmission occasions for the one or more TBs 514 over a set of resources of the PSSCH during the period of the grant. In aspects, the PSSCH configuration 510 may be indicative of the set of resources in the period of the grant. In aspects, the PSSCH configuration 510 may be indicative of at least one of a number of TBs or a maximum number of TBs for the period of the grant. In aspects, the PSSCH configuration 510 may be indicative of at least one respective resource of the set of resources in the period of the grant for each TB of the one or more TBs 514.

The UE 502 may be configured to select (at 512) at least one resource of the set of resources for the transmission of the one or more TBs 514. In aspects for which the PSSCH configuration 510 is indicative of the set of resources in the period of the grant, the UE 502 may be configured to select (at 512) at least one resource of the set of resources for the transmission of the one or more TBs 514 in accordance with the indicated set of resources. In aspects for which the PSSCH configuration 510 is indicative of at least one of a number of TBs or a maximum number of TBs for the period of the grant, the UE 502 may be configured to select (at 512) at least one resource of the set of resources for the transmission of the one or more TBs 514 further in accordance with at least one of the number of TBs or the maximum number of TBs and/or in accordance with the indicated set of resources includes selecting a number of resources of the set of resources for transmitting each TB of the one or more TBs 514. In aspects for which the PSSCH configuration 510 is indicative of at least one respective resource of the set of resources in the period of the grant for each TB of the one or more TBs 514, the UE 502 may be configured to select (at 512) at least one resource of the set of resources for the transmission of the one or more TBs 514.

The UE 502 may be configured to transmit, via the PSSCH, and the SL UE 803 may be configured to receive, one or more TBs 514 during the period of the grant in accordance with the PSSCH configuration 510. In aspects, transmissions with multiple TOs for the one or more TBs 514 may be associated with XR communications, e.g., video communications, for an XR application. In aspects for which the PSSCH configuration 510 is indicative of at least one respective resource of the set of resources in the period of the grant for each TB of the one or more TBs 514, the UE 502 may be configured to transmit the one or more TBs 514 during the period of the grant in accordance with the at least one respective resource of the set of resources in the period of the grant for each TB of the one or more TBs 514. The UE 502 may be configured to transmit, via SCI for the SL UE 503 and in a current resource of the at least one respective resource of the set of resources, a resource indication of a subsequent one of the at least one respective resource for a TB of the one or more TBs 514 associated with the current resource. In such aspects, a first set of respective resources of the set of resources for a first TB of the one or more TBs 514 may be before a second set of respective resources of the set of resources for a second TB of the one or more TBs 514 during the period of the grant. The UE 502 may be configured to transmit, via the SCI for the SL UE and in the current resource of the at least one respective resource of the set of resources, the resource indication including a set of unique HARQ process identifiers respectively associated with each of the one or more TBs 514.

In some aspects, the PSSCH configuration 510 may be further indicative of a set of PUCCH resources associated with the period of the grant. In such aspects, the UE 502 may be configured to receive, from the SL UE 503 via a PSFCH, HARQ feedback associated with the one or more TBs 514 (e.g., subsequent to transmission thereof). The UE 502 may be configured to transmit, to a network node (e.g., the base station 504) via the set of PUCCH resources, an indication of the HARQ feedback associated with the multiple TBs 514. In some aspects, the set of PUCCH resources may include a single PUCCH resource, the indication of the HARQ feedback associated with the one or more TBs 514 may include one bit that indicates a successful transmission of the one or more TBs 514 or an unsuccessful transmission of at least one of the one or more TBs 514, the UE 502 may be configured to transmit the indication of the HARQ feedback subsequent to a last resource of the set of resources of the PSSCH during the period of the grant. In some aspects, the set of PUCCH resources includes a single PUCCH resource, the indication of the HARQ feedback associated with the one or more TBs 514 may include a set of bits that indicates a successful transmission or an unsuccessful transmission for a corresponding one of the one or more TBs 514, the set of bits may include a number of bits equal to at least one of a number of TBs or a maximum number of TBs for the period of the grant, and the UE 502 may be configured to transmit the indication of the HARQ feedback subsequent to a last resource of the set of resources of the PSSCH during the period of the grant. In some aspects, the set of PUCCH resources may include one or more PUCCH resources that are less than or equal to a number of TBs or a maximum number of TBs for the period of the grant, and the UE 502 may be configured to transmit a respective indication of the HARQ feedback for a TB of the one or more TBs 514 in a corresponding PUCCH resource of the set of PUCCH resources prior to a next TB of the one or more TBs.

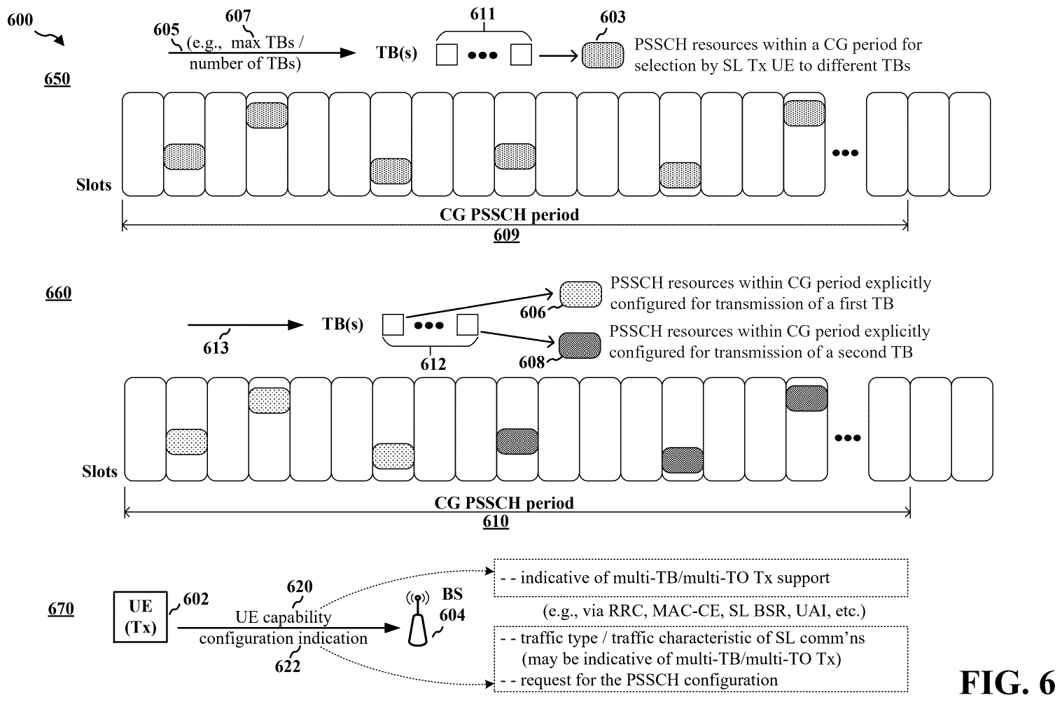

FIG. 6 is a diagram 600 illustrating example CG configurations for increased SL transmission capacity, in various aspects. Diagram 600 shows a configuration 650, a configuration 660, and a configuration 670 for configuring multiple PSSCH transmission occasions within a CG period for transmitting one or more/more than one TBs (e.g., multiple TBs) over SL. Diagram 600 may reflect aspects of call flow diagram 500 in FIG. 5. In reference to diagram 600, a UE/SL Tx UE may refer to a UE 602.

A UE, e.g., a SL Tx UE, may be configured by a network node such as a base station, gNB, etc., for multi-TB/multi-TO PSSCH resources within a CG period for SL transmissions. As described herein a network node may so configure a UE via a PSSCH configuration (also referred to as a CG configuration) for transmission of multiple TBs in such a set of resources in slots of a period for a CG.

In the configuration 650, a PSSCH configuration 605 received by a UE may indicate multiple PSSCH transmission resources (e.g., a set of resources including resources 606) within a CG period 609 (shown as 6 PSSCH resources, by way of example). The UE utilizing resources in the set of resources 603 may be configured to select/allocate resources in the set of resources 603 for transmitting one or more TBs 611 within the CG period 609. That is, the UE may be allowed to transmit more than one new TB as the one or more TBs 611 within the CG period 609.

In another example, shown with the configuration 650, the PSSCH configuration 605 (e.g., a CG configuration) may explicitly indicate a number of TBs and/or a maximum number of TBs 607 for the one or more TBs 611 that the UE may transmit within the CG period 609, in addition to the configuration of multiple PSSCH transmission resources (e.g., the resources 606). The UE utilizing resources in the set of resources 603 may be configured to select/allocate these SL resources to different TBs of the multiple TBs 611.

In another example, such as for the configuration 660, a PSSCH configuration 613 (e.g., a CG configuration) explicitly indicate resources (e.g., a set of resources including the resources 606 and the resources 608) to be utilized for each TB in one or more TBs 612 that are allowed in a CG period 610. That is, multiple PSSCH transmission resources are configured per TB.

With reference to the configuration 670, the UE 602 may be configured to transmit/provide, to a base station 604, a UE capability 620 and/or a configuration indication 622 associated with transmissions of TBs, such as the one or more TBs 611 and/or the one or more TBs 612. In aspects, the UE capability 620 of the UE 602 may indicate UE 602 support of transmissions for multiple transmission occasions for the one or more TBs 611/the one or more TBs 612 (e.g., multi-TB/multi-TO Tx). In aspects, the configuration indication 622 may include a traffic type(s) and/or a traffic characteristic(s) for the UE 602 associated with SL (e.g., for XR communications, such as video over SL). The traffic type(s)/traffic characteristic(s) may imply or indicate a potential multi-TB multi-TO CG PSSCH configuration, such as PSSCH configuration 605/the PSSCH configuration 613, and the base station 604 may determine/identify whether and/or when to configure a multi-TB multi-TO PSSCH configuration for the UE 602 (e.g., based on the UE 602 traffic type/characteristics, availability of SL resources, etc.). In another example, the UE 602 may indicate explicitly in the configuration indication 622 to the base station 604 for the multi-TB multi-TO CG PSSCH configuration (e.g., the UE 602 may explicitly request a PSSCH configuration (e.g., the PSSCH configuration 605/the PSSCH configuration 613) of CG PSSCH resources (e.g., the set of resources 603 for the one or more TBs 611/a set of resources comprising the resources 606 and the resources 608 for the one or more TBs 612, per CG period).

In some aspects, the UE capability 620 and/or the configuration indication 622 may be transmitted/provided via RRC message, MAC-CE, SL BSR, UAI, etc. In aspects, the base station 604 may be configured to generate/apply a PSSCH configuration (e.g., the PSSCH configuration 605/the PSSCH configuration 613) based on/associated with at least one of the UE capability 620 of the UE 602 and/or the configuration indication 622 associated with the transmissions of more than one TB in a CG period (e.g., based on UE 602 traffic characteristics, availability of SL resources, etc.).

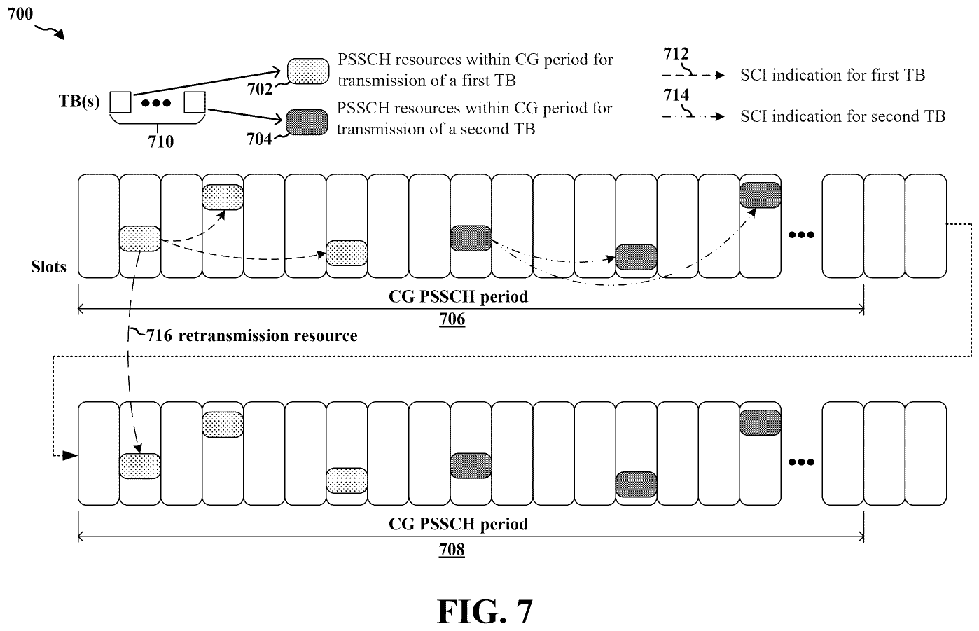

FIG. 7 is a diagram 700 illustrating example CG resources for increased SL transmission capacity, in various aspects. Diagram 600 shows CG resource utilization and configurations for multiple PSSCH transmission occasions within a CG period for transmitting one or more, or more than one, TBs (e.g., multiple TBs) over SL. Diagram 600 may reflect aspects of call flow diagram 500 in FIG. 5 and may reference aspects described above for diagram 600 in FIG. 6.

In aspects, per-TB resources may be configured by a network node (e.g., a base station, a gNB, etc.) for a SL Tx UE via a PSSCH/CG configuration (e.g., as described above for the configuration 660 in FIG. 6). The SL Tx UE may be configured to utilize the resources as indicated by the PSSCH/CG configuration, and the SL Tx UE may not be allowed to (e.g., may not) transmit more than one TB using the PSSCH resources configured for a single TB. As shown, resources 702 (e.g., a first subset of PSSCH resources) within a CG period 706 for transmission of a first TB of one or more TBs 710 and resources 704 (e.g., a second subset of PSSCH resources) within the CO period 706 for transmission of a second TB of the one or more TBs 710. The resources 702 and the resources 704 may comprise a set of resources, as described herein for aspects. In aspects, a first number of PSSCH resources configured for a first TB may be prior to a second number of PSSCH resources configured for a second TB. For instance, the resources 702 (e.g., a first subset of PSSCH resources) within the CG period 706 for transmission of a first TB of the one or more TBs 710 may each be configured/allocated to be prior to the resources 704 (e.g., a second subset of PSSCH resources) within the CG period 706 for transmission of a second TB of the one or more TBs 710. Accordingly, HARQ feedback for the one or more TBs 710 may be correctly and efficiently managed, as described in further detail herein.

When transmitting over SL in a PSSCH resource configured by the PSSCH/CG configuration, the SL Tx UE may also be configured to indicate, in its SCI and to a SL Rx UE, the subsequent PSSCH resources used for the same TB within the same CG period, as a retransmission resource 716 for HARQ (e.g., the SL Tx UE, in its SCI, does indicate to the SL Rx UE resources belonging to a different TB within the same CG period). As shown in diagram 700, an SCI indication 712 for the first TB associated with the resources 702 indicates subsequent ones of the resources 702 in the CG period 706, but does not indicate ones of the resources 704 associated with the second TB. Likewise, an SCI indication 714 for the second TB associated with the resources 704 indicates subsequent ones of the resources 704 in the CG period 706, but does not indicate other resources associated with a different TB.

The retransmission resource 716 may be indicated in one of the resources 702 (or in one of the resources 704) in the CG period 706 to refer to the one of the resources 702 in the CG period 708 for HARQ retransmission of the associated TB. Regarding SL HARQ, a SL HARQ process identifier (ID) may be set by the SL Tx UE. When assigning PSCCH resources, such as the resources 702/the resources 704, within the CG period 706 to different TBs of the one or more TBs 710 (as shown), the SL Tx UE may be configured to ensures that HARQ process IDs are correctly configured and unique for different TBs. For example, the SL Tx UE may set HARQ process IDs to ensure that for transmissions of different TBs in a CG period, a HARQ process ID carried in SCI-2 (second stage SCI) for the different TBs are different/unique.

In aspects, for per-TB resources are configured, the SL Tx UE may be configured to determine/identify/select the resources to be utilized for ones of the one or more/multiple TBs (e.g., as described above for the configuration 650 in FIG. 6. In one example, a number of TBs to be transmitted in the CG period 706 and/or a CG period 708 may also be determined/identified/selected by the Tx UE. In the illustrated example for diagram 700, 6 PSSCH resources (e.g., the resources 702 and the resources 704 (having 3 resources, respectively)) are configured in the CG period 706 and the CG period 708. The Tx UE may be configured to select such resources to transmit 3 TBs (e.g., 2 resources per TB), to transmit 2 TBs (e.g., 3 resources per TB, as shown), or to transmit a single TB across all 6 resources. That is, aspects enable one or more TBs per transmission occasion.

In aspects, number of TBs may be indicated by the PSSCH/CG configuration from the network node (e.g., 6 PSSCH resources, as shown) for a CG period (e.g., the CG period 706 and/or a CG period 708). As an example, the PSSCH/CG configuration may also indicate a number or maximum number of TBs per CG period, such as 2 TBs per CG period, and the SL Tx UE may not transmit more than 2 TBs in a CG period so configured. In such aspects, the number (e.g., 2) of TBs indicated by the PSSCH/CG configuration may be the maximum number of TBs allowed per CG period, e.g., if 2 TBs are configured, and the SL Tx UE may be allowed to send 0/1/2 TBs in a CG period.

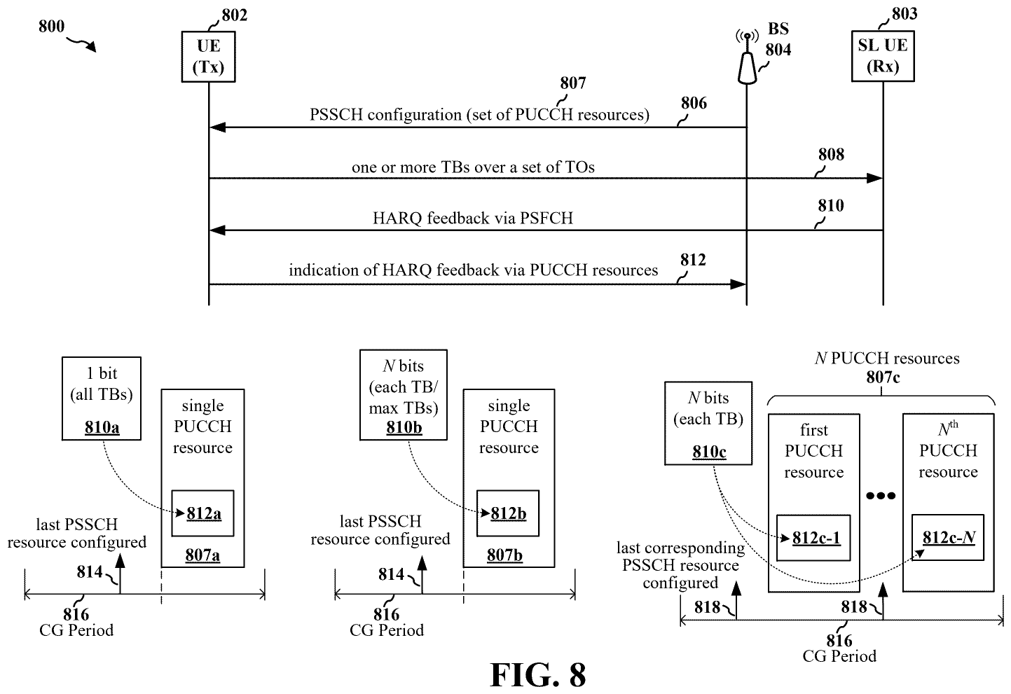

FIG. 8 is a diagram 800 illustrating example configurations for HARQ feedback, in various aspects. Diagram 800 shows a configuration for a set of PUCCH resources utilized for HARQ feedback associated with SL transmissions of one or more/multiple TBs over multiple TOs in a CG period for increased SL transmission capacity. Diagram 800 is described with reference to a UE 802 (e.g., a SL Tx UE) that communicates with a SL UE 803 (e.g., an XR device and/or a SL Rx UE) via various forms of SL communications, as well as with a wireless network with one or more network nodes (e.g., a base station 804, such as a gNB or other type of base station or a DU(s), by way of example, as shown and described herein), in various aspects. Additionally, or alternatively, operations for increased SL transmission capacity may be performed by the UE 802 autonomously in addition to, or in lieu of, configurations provided to from the base station 804. Diagram 800 may reflect aspects of call flow diagram 500 in FIG. 5.

As described above for the call flow diagram 500 in FIG. 5, a SL Tx UE (e.g., the UE 802) may be configured to receive a PSSCH configuration for a CG (e.g., a PSSCH configuration 806) from a base station (e.g., the base station 804) indicative of the grant (e.g., the CG) associated with a set of transmission occasions for one or more/multiple TBs 808 over a set of resources of the PSSCH during the period of the grant. In aspects, the PSSCH configuration 806 may also indicate PUCCH resource(s) used for/by the UE 802. That is, the UE 802 may be configured to receive, and the base station 804 may be configured to transmit/provide, a PSSCH configuration 806 that includes or is indicative of a set of PUCCH resources 807 associated with the period of a grant for SL transmission of one or more/multiple TBs over multiple TOs, as described herein. The UE 802 may be configured to transmit/provide, and the SL UE 803 may be configured to receive, the one or more TBs 808 over a set of TOs in a CG period, as described herein (e.g., with respect to FIGS. 5-7).

In aspects for which SL HARQ feedback is enabled (e.g., when PSFCH resources are configured), the UE 802 may be configured to receive, and the SL UE 803 may be configured to transmit/provide, HARQ feedback 810 associated with the one or more TBs 808. The UE 802 may be configured to transmit/provide, and the base station 804 may be configured to receive, an indication 812 of the HARQ feedback associated with the one or more TBs 808. In some aspects, the SL UE 803 may be configured to transmit/provide the HARQ feedback 810 to the UE 802 over SL/PSFCH, and the UE 802 may be configured to transmit/provide the indication 812 of the HARQ feedback to the base station 804 in UL using the set of PUCCH resources 807 (e.g., based on/in accordance with the HARQ feedback 810 received from the SL UE 803 via SL).

In some aspects, the set of PUCCH resources 807 may comprise or include a single PUCCH resource as configured for the UE 802 in the PSSCH configuration 806. In such aspects, the single PUCCH resource may be configured for the UE 802 per CG period.

In one such example, a single bit (e.g., 1 bit) may be utilized for the HARQ feedback 810 (e.g., an aspect shown as HARQ feedback 810a) to be provided to the base station 804 via the set of PUCCH resources 807. Is such cases, the set of PUCCH resources may be a single PUCCH resource 807a for UL transmission of an indication 812a (e.g., an aspect of the indication 812). The one/single bit of the HARQ feedback 810a may indicate that the one or more TBs 808 are successfully delivered to the SL UE 803 over SL if all TBs of the one or more TBs 808 are successfully delivered to all SL Rx UE(s) for a CG period 816 (e.g., a NACK is not received over SL from Rx UEs). Otherwise, the HARQ feedback 810a may indicate unsuccessful delivery for the one or more TBs 808.

In another such example, a number of bits (e.g., N bits) may be utilized for the HARQ feedback 810 (e.g., an aspect shown as HARQ feedback 810b) to be provided to the base station 804 via the set of PUCCH resources 807. Is such cases, the set of PUCCH resources may be a single PUCCH resource 807b for UL transmission of an indication 812b (e.g., an aspect of the indication 812). The number of bits N for the HARQ feedback 810b and in the single PUCCH resource 807b may be the same as the number of TBs in the one or more TBs 808 and/or the maximum number of TBs allowed in the CG period 816, and each bit of the N bits in the single PUCCH resource 807b may indicate whether the corresponding TB of the one or more TBs 808 is successfully delivered or not to SL Rx UE(s) (e.g., the SL UE 803).

In aspects for single PUCCH resource utilization in HARQ feedback per CG period (e.g., the single PUCCH resource 807a/the single PUCCH resource 807b in the CG period 816), the single PUCCH resource may be later than a last configured PSSCH resource 814 in the CG period 816.

In some aspects, the set of PUCCH resources 807 may be multiple PUCCH resources/a set of PUCCH resources 807c (e.g., N PUCCH resources) and may be configured to a SL Tx UE (e.g., the UE 802) per CG period (for the CG period 816) in the PSSCH configuration 806. The number N of PUCCH resources in the set of PUCCH resources 807c may be less than or equal to a number of TBs or a maximum number of TBs allowed for the CG period 816. In one such example, each PUCCH resource of the number N of the set of PUCCH resources 807c may be utilized by the UE 802 to transmit/provide the HARQ feedback 810 (e.g., an aspect shown as HARQ feedback 810c) for the corresponding TB. That is, the UE 802 may be configured to transmit a respective indication of the HARQ feedback 810 (e.g., an indication 812c-1 to an indication 812c-N) for a TB of the one or more TBs 808 in a corresponding PUCCH resource of the set of PUCCH resources 807c (e.g., as a first PUCCH resource to an Nth PUCCH resource) prior to a next TB of the one or more TBs 808. As an example, the set of PUCCH resources 807c may be scattered/allocated/configured within the CG period 816, such that a given PUCCH resource of the set of PUCCH resources 807c follows a corresponding last PSSCH resource 818 configured for each TB of the one or more TBs 808.

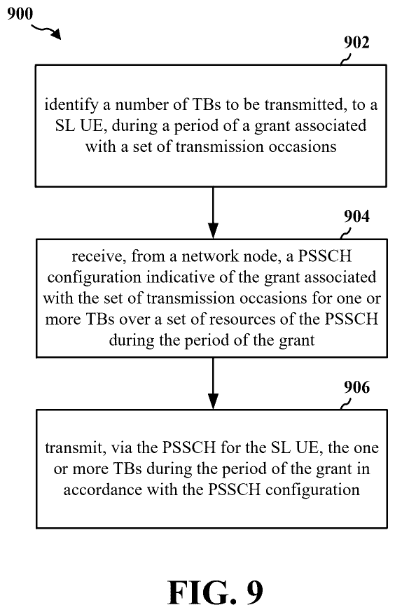

FIG. 9 is a flowchart 900 of a method of wireless communication. The method may be performed by a UE such as a SL Tx UE (e.g., the UE 104, 412, 454, 502, 602, 802; the apparatus 1104). In some aspects, the method may include aspects described in connection with the communication flows in FIG. 5, and/or aspects described in FIGS. 6-8. The method may be for increased SL transmission capacity. The method may enable high-capacity traffic over SL by utilizing CG PSSCH with multiple TOs for one or more/multiple TBs within a CG period with flexibility in resource selection/utilization by a SL Tx UE and HARQ feedback for SL transmissions with multiple TOs for one or more/multiple TBs within a CG period via PUCCH resources indications in a CG PSSCH.

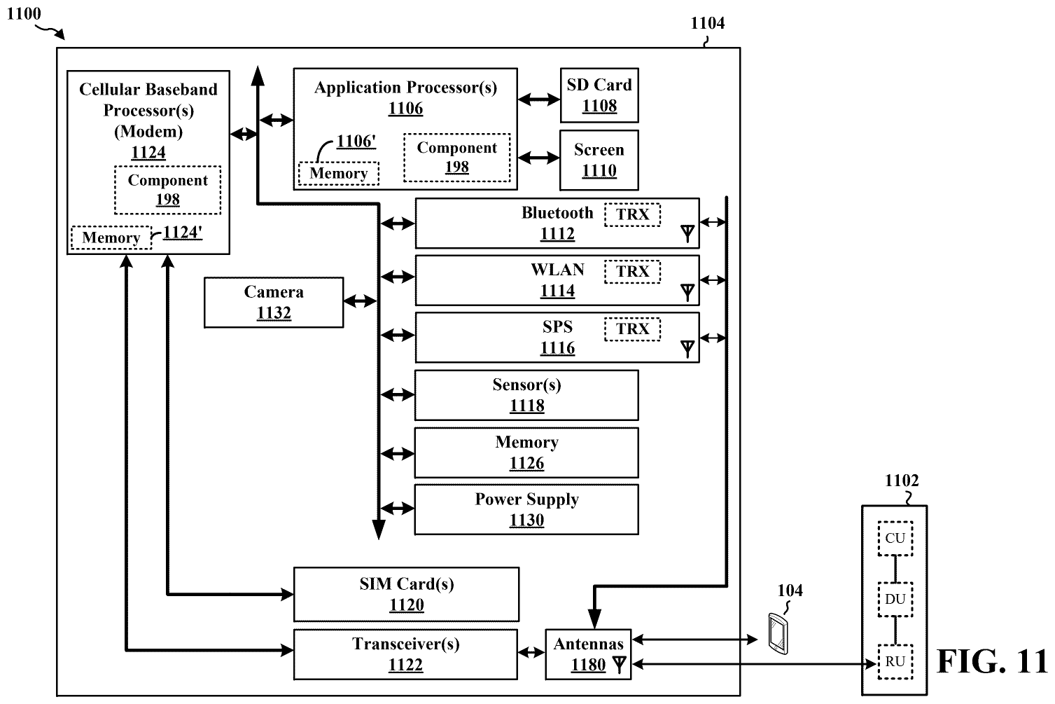

At 902, the UE identifies a number of TBs to be transmitted, to a SL UE, during a period of a grant associated with a set of transmission occasions. As an example, the identification may be performed by one or more of the component 198, the transceiver(s) 1122, and/or the antenna 1180 in FIG. 11. FIG. 5 illustrates, in the context of FIGS. 6-8, an example of the UE 502 identifying such a number of TBs to be transmitted.

The UE 502 may be configured to identify (at 508) a number of TBs to be transmitted, to the SL UE 503, during a period of a grant associated with a set of transmission occasions. In aspects, the UE 502 may identify (at 508) the number of TBs to be transmitted during the period of the grant associated with the set of transmission occasions prior or subsequent to transmitting the UE capability/configuration indication 506 to the base station 504. In aspects, the number of TBs to be transmitted to the SL UE 503 during a period of a grant may be identified (at 508) based on desired video communications for an XR application associated with at least one of the UE 502 and/or the SL UE 503.

At 904, the UE receives, from a network node, a PSSCH configuration indicative of the grant associated with the set of transmission occasions for one or more TBs over a set of resources of the PSSCH during the period of the grant. As an example, the reception may be performed by one or more of the component 198, the transceiver(s) 1122, and/or the antenna 1180 in FIG. 11. FIG. 5 illustrates, in the context of FIGS. 6-8, an example of the UE 502 receiving such a PSSCH configuration from a network node (e.g., the base station 504).

The PSSCH configuration 510 may be associated with at least one of the capability of the UE 502 and/or the configuration indication associated with the transmissions of TBs, in aspects. The UE 502 may be configured to receive, and the base station 504 may be configured to transmit/provide, the PSSCH configuration 510. The PSSCH configuration 510 may be indicative of the grant associated with the set of transmission occasions for the one or more TBs 514 over a set of resources of the PSSCH during the period of the grant. In aspects, the PSSCH configuration 510 may be indicative of the set of resources in the period of the grant. In aspects, the PSSCH configuration 510 may be indicative of at least one of a number of TBs or a maximum number of TBs for the period of the grant. In aspects, the PSSCH configuration 510 may be indicative of at least one respective resource of the set of resources in the period of the grant for each TB of the one or more TBs 514.

At 906, the UE transmits, via the PSSCH for the SL UE, the one or more TBs during the period of the grant in accordance with the PSSCH configuration. As an example, the transmission may be performed by one or more of the component 198, the transceiver(s) 1122, and/or the antenna 1180 in FIG. 11. FIG. 5 illustrates, in the context of FIGS. 6-8, an example of the UE 502 transmitting such one or more/multiple TBs for a SL Rx UE (e.g., the SL UE 503).

The UE 502 may be configured to select (at 512) at least one resource of the set of resources for the transmission of the one or more TBs 514. In aspects for which the PSSCH configuration 510 is indicative of the set of resources in the period of the grant, the UE 502 may be configured to select (at 512) at least one resource of the set of resources for the transmission of the one or more TBs 514 in accordance with the indicated set of resources. In aspects for which the PSSCH configuration 510 is indicative of at least one of a number of TBs or a maximum number of TBs for the period of the grant, the UE 502 may be configured to select (at 512) at least one resource of the set of resources for the transmission of the one or more TBs 514 further in accordance with at least one of the number of TBs or the maximum number of TBs and/or in accordance with the indicated set of resources includes selecting a number of resources of the set of resources for transmitting each TB of the one or more TBs 514. In aspects for which the PSSCH configuration 510 is indicative of at least one respective resource of the set of resources in the period of the grant for each TB of the one or more TBs 514, the UE 502 may be configured to select (at 512) at least one resource of the set of resources for the transmission of the one or more TBs 514.

The UE 502 may be configured to transmit, via the PSSCH, and the SL UE 803 may be configured to receive, one or more TBs 514 during the period of the grant in accordance with the PSSCH configuration 510. In aspects, transmissions with multiple TOs for the one or more TBs 514 may be associated with XR communications, e.g., video communications, for an XR application. In aspects for which the PSSCH configuration 510 is indicative of at least one respective resource of the set of resources in the period of the grant for each TB of the one or more TBs 514, the UE 502 may be configured to transmit the one or more TBs 514 during the period of the grant in accordance with the at least one respective resource of the set of resources in the period of the grant for each TB of the one or more TBs 514. The UE 502 may be configured to transmit, via SCI for the SL UE 503 and in a current resource of the at least one respective resource of the set of resources, a resource indication of a subsequent one of the at least one respective resource for a TB of the one or more TBs 514 associated with the current resource. In such aspects, a first set of respective resources of the set of resources for a first TB of the one or more TBs 514 may be before a second set of respective resources of the set of resources for a second TB of the one or more TBs 514 during the period of the grant. The UE 502 may be configured to transmit, via the SCI for the SL UE and in the current resource of the at least one respective resource of the set of resources, the resource indication including a set of unique HARQ process identifiers respectively associated with each of the one or more TBs 514.

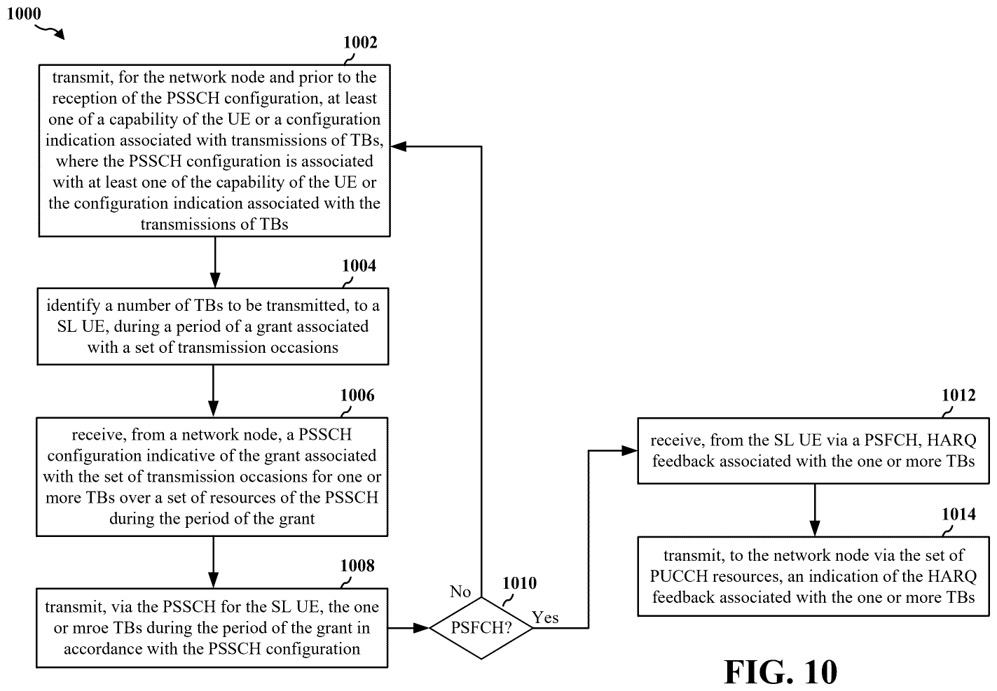

FIG. 10 is a flowchart 1000 of a method of wireless communication. The method may be performed by a UE such as a SL Tx UE (e.g., the UE 104, 412, 454, 502, 602, 802; the apparatus 1104). In some aspects, the method may include aspects described in connection with the communication flows in FIG. 5, and/or aspects described in FIGS. 6-8. The method may be for increased SL transmission capacity. The method may enable high-capacity traffic over SL by utilizing CG PSSCH with multiple TOs for one or more/multiple TBs within a CG period with flexibility in resource selection/utilization by a SL Tx UE and HARQ feedback for SL transmissions with multiple TOs for one or more/multiple TBs within a CG period via PUCCH resources indications in a CG PSSCH.

At 1002, the UE transmits, for the network node and prior to the reception of the PSSCH configuration, at least one of a capability of the UE or a configuration indication associated with transmissions of TBs, where the PSSCH configuration is associated with at least one of the capability of the UE or the configuration indication associated with the transmissions of TBs. As an example, the transmission may be performed by one or more of the component 198, the transceiver(s) 1122, and/or the antenna 1180 in FIG. 11. FIG. 5 illustrates, in the context of FIGS. 6-8, an example of the UE 502 transmitting such a capability of the UE/a configuration indication for a network node (e.g., the base station 504).

The UE 502 may be configured to transmit/provide, and the base station 504, may be configured to receive, a UE capability/configuration indication 506. The UE capability/configuration indication 506 may include at least one of a capability of the UE and/or a configuration indication associated with transmissions of TBs, e.g., by the UE 502. The transmission/provision of the UE capability/configuration indication 506 may occur prior to the reception of PSSCH configuration, as described herein, e.g., for a PSSCH configuration 510. In aspects, a configuration indication of the UE capability/configuration indication 506 may include at least one of a traffic type or a traffic characteristic associated with SL communications. At least one of the traffic type or the traffic characteristic may be indicative of transmissions for multiple transmission occasions for one or more/multiple TBs (e.g., one or more TBs 514). In some aspects, the configuration indication may include a request for a PSSCH configuration, as described herein. In aspects, the capability of the UE 502 for the UE capability/configuration indication 506 may be indicative of UE support, e.g., of the UE 502, for transmissions for multiple transmission occasions for the one or more/multiple TBs (e.g., one or more TBs 514). In aspects, to transmit the capability of the UE 502 for the UE capability/configuration indication 506, the UE 502 may be configured to transmit the capability of the UE 502 for the UE capability/configuration indication 506 via at least one of a radio resource control (RRC) message, a medium access control (MAC) control element (MAC-CE), a SL buffer status report (BSR), or UAI.

At 1004, the UE identifies a number of TBs to be transmitted, to a SL UE, during a period of a grant associated with a set of transmission occasions. As an example, the identification may be performed by one or more of the component 198, the transceiver(s) 1122, and/or the antenna 1180 in FIG. 11. FIG. 5 illustrates, in the context of FIGS. 6-8, an example of the UE 502 identifying such a number of TBs to be transmitted.

The UE 502 may be configured to identify (at 508) a number of TBs to be transmitted, to the SL UE 503, during a period of a grant associated with a set of transmission occasions. In aspects, the UE 502 may identify (at 508) the number of TBs to be transmitted during the period of the grant associated with the set of transmission occasions prior or subsequent to transmitting the UE capability/configuration indication 506 to the base station 504. In aspects, the number of TBs to be transmitted to the SL UE 503 during a period of a grant may be identified (at 508) based on desired video communications for an XR application associated with at least one of the UE 502 and/or the SL UE 503.

At 1006, the UE receives, from a network node, a PSSCH configuration indicative of the grant associated with the set of transmission occasions for one or more TBs over a set of resources of the PSSCH during the period of the grant. As an example, the reception may be performed by one or more of the component 198, the transceiver(s) 1122, and/or the antenna 1180 in FIG. 11. FIG. 5 illustrates, in the context of FIGS. 6-8, an example of the UE 502 receiving such a PSSCH configuration from a network node (e.g., the base station 504).

The PSSCH configuration 510 may be associated with at least one of the capability of the UE 502 and/or the configuration indication associated with the transmissions of TBs, in aspects. The UE 502 may be configured to receive, and the base station 504 may be configured to transmit/provide, the PSSCH configuration 510. The PSSCH configuration 510 may be indicative of the grant associated with the set of transmission occasions for the one or more TBs 514 over a set of resources of the PSSCH during the period of the grant. In aspects, the PSSCH configuration 510 may be indicative of the set of resources in the period of the grant. In aspects, the PSSCH configuration 510 may be indicative of at least one of a number of TBs or a maximum number of TBs for the period of the grant. In aspects, the PSSCH configuration 510 may be indicative of at least one respective resource of the set of resources in the period of the grant for each TB of the one or more TBs 514.

At 1008, the UE transmits, via the PSSCH for the SL UE, the one or more TBs during the period of the grant in accordance with the PSSCH configuration. As an example, the transmission may be performed by one or more of the component 198, the transceiver(s) 1122, and/or the antenna 1180 in FIG. 11. FIG. 5 illustrates, in the context of FIGS. 6-8, an example of the UE 502 transmitting such one or more/multiple TBs for a SL Rx UE (e.g., the SL UE 503).

The UE 502 may be configured to select (at 512) at least one resource of the set of resources for the transmission of the one or more TBs 514. In aspects for which the PSSCH configuration 510 is indicative of the set of resources in the period of the grant, the UE 502 may be configured to select (at 512) at least one resource of the set of resources for the transmission of the one or more TBs 514 in accordance with the indicated set of resources. In aspects for which the PSSCH configuration 510 is indicative of at least one of a number of TBs or a maximum number of TBs for the period of the grant, the UE 502 may be configured to select (at 512) at least one resource of the set of resources for the transmission of the one or more TBs 514 further in accordance with at least one of the number of TBs or the maximum number of TBs and/or in accordance with the indicated set of resources includes selecting a number of resources of the set of resources for transmitting each TB of the one or more TBs 514. In aspects for which the PSSCH configuration 510 is indicative of at least one respective resource of the set of resources in the period of the grant for each TB of the one or more TBs 514, the UE 502 may be configured to select (at 512) at least one resource of the set of resources for the transmission of the one or more TBs 514.

The UE 502 may be configured to transmit, via the PSSCH, and the SL UE 803 may be configured to receive, one or more TBs 514 during the period of the grant in accordance with the PSSCH configuration 510. In aspects, transmissions with multiple TOs for the one or more TBs 514 may be associated with XR communications, e.g., video communications, for an XR application. In aspects for which the PSSCH configuration 510 is indicative of at least one respective resource of the set of resources in the period of the grant for each TB of the one or more TBs 514, the UE 502 may be configured to transmit the one or more TBs 514 during the period of the grant in accordance with the at least one respective resource of the set of resources in the period of the grant for each TB of the one or more TBs 514. The UE 502 may be configured to transmit, via SCI for the SL UE 503 and in a current resource of the at least one respective resource of the set of resources, a resource indication of a subsequent one of the at least one respective resource for a TB of the one or more TBs 514 associated with the current resource. In such aspects, a first set of respective resources of the set of resources for a first TB of the one or more TBs 514 may be before a second set of respective resources of the set of resources for a second TB of the one or more TBs 514 during the period of the grant. The UE 502 may be configured to transmit, via the SCI for the SL UE and in the current resource of the at least one respective resource of the set of resources, the resource indication including a set of unique HARQ process identifiers respectively associated with each of the one or more TBs 514.

At 1010, the UE determines/identifies whether PSFCH is enabled with a SL Rx UE (e.g., the SL UE 503 in FIG. 5) for HARQ feedback. As an example, the determination/identification may be performed by one or more of the component 198, the transceiver(s) 1122, and/or the antenna 1180 in FIG. 11. If PSFCH is enabled, flowchart 1000 continues to 1012; if not, flowchart 1000 may return to 1002.

At 1012, the UE receives, from the SL UE via a PSFCH, HARQ feedback associated with the one or more TBs. As an example, the reception may be performed by one or more of the component 198, the transceiver(s) 1122, and/or the antenna 1180 in FIG. 11. FIGS. 5, 8 describe/illustrate, in the context of FIGS. 6, 7, an example of the UE 502 receiving such HARQ feedback from a SL Rx UE (e.g., the SL UE 503).

In some aspects, the PSSCH configuration 510 may be further indicative of a set of PUCCH resources associated with the period of the grant. In such aspects, the UE 502 may be configured to receive, from the SL UE 503 via a physical sidelink feedback channel (PSFCH), HARQ feedback associated with the one or more TBs 514 (e.g., subsequent to transmission thereof).

With reference to FIG. 8, as described above for the call flow diagram 500 in FIG. 5, a SL Tx UE (e.g., the UE 802) may be configured to receive a PSSCH configuration for a CG (e.g., a PSSCH configuration 806) from a base station (e.g., the base station 804) indicative of the grant (e.g., the CG) associated with a set of transmission occasions for one or more TBs 808 over a set of resources of the PSSCH during the period of the grant. In aspects, the PSSCH configuration 806 may also indicate PUCCH resource(s) used for/by the UE 802. That is, the UE 802 may be configured to receive, and the base station 804 may be configured to transmit/provide, a PSSCH configuration 806 that includes or is indicative of a set of PUCCH resources 807 associated with the period of a grant for SL transmission of one or more/multiple TBs over multiple TOs, as described herein. The UE 802 may be configured to transmit/provide, and the SL UE 803 may be configured to receive, the one or more TBs 808 over a set of TOs in a CG period, as described herein (e.g., with respect to FIGS. 5-7). In aspects for which SL HARQ feedback is enabled (e.g., when PSFCH resources are configured), the UE 802 may be configured to receive, and the SL UE 803 may be configured to transmit/provide, HARQ feedback 810 associated with the one or more TBs 808. The UE 802 may be configured to transmit/provide, and the base station 804 may be configured to receive, an indication 812 of the HARQ feedback associated with the one or more TBs 808.

At 1014, the UE transmits, to the network node via the set of PUCCH resources, an indication of the HARQ feedback associated with the one or more TBs. As an example, the transmission may be performed by one or more of the component 198, the transceiver(s) 1122, and/or the antenna 1180 in FIG. 11. FIGS. 5, 8 describe/illustrate, in the context of FIGS. 6, 7, an example of the UE 502 transmitting such an indication of HARQ feedback for a network node (e.g., the base station 504).

With reference to FIG. 5, in aspects, the PSSCH configuration 510 may be further indicative of a set of PUCCH resources associated with the period of the grant. In such aspects, the UE 502 may be configured to receive, from the SL UE 503 via a physical sidelink feedback channel (PSFCH), HARQ feedback associated with the one or more TBs 514 (e.g., subsequent to transmission thereof). The UE 502 may be configured to transmit, to a network node (e.g., the base station 504) via the set of PUCCH resources, an indication of the HARQ feedback associated with the one or more TBs 514. In some aspects, the set of PUCCH resources may include a single PUCCH resource, the indication of the HARQ feedback associated with the one or more TBs 514 may include one bit that indicates a successful transmission of the one or more TBs 514 or an unsuccessful transmission of at least one of the one or more TBs 514, the UE 502 may be configured to transmit the indication of the HARQ feedback subsequent to a last resource of the set of resources of the PSSCH during the period of the grant. In some aspects, the set of PUCCH resources includes a single PUCCH resource, the indication of the HARQ feedback associated with the one or more TBs 514 may include a set of bits that indicates a successful transmission or an unsuccessful transmission for a corresponding one of the one or more TBs 514, the set of bits may include a number of bits equal to at least one of a number of TBs or a maximum number of TBs for the period of the grant, and the UE 502 may be configured to transmit the indication of the HARQ feedback subsequent to a last resource of the set of resources of the PSSCH during the period of the grant. In some aspects, the set of PUCCH resources may include multiple PUCCH resources that are less than or equal to a number of TBs or a maximum number of TBs for the period of the grant, and the UE 502 may be configured to transmit a respective indication of the HARQ feedback for a TB of the one or more TBs 514 in a corresponding PUCCH resource of the set of PUCCH resources prior to a next TB of the one or more/multiple TBs.

With reference to FIG. 8, as described above for the call flow diagram 500 in FIG. 5, a SL Tx UE (e.g., the UE 802) may be configured to receive a PSSCH configuration for a CG (e.g., a PSSCH configuration 806) from a base station (e.g., the base station 804) indicative of the grant (e.g., the CG) associated with a set of transmission occasions for one or more TBs 808 over a set of resources of the PSSCH during the period of the grant. In aspects, the PSSCH configuration 806 may also indicate PUCCH resource(s) used for/by the UE 802. That is, the UE 802 may be configured to receive, and the base station 804 may be configured to transmit/provide, a PSSCH configuration 806 that includes or is indicative of a set of PUCCH resources 807 associated with the period of a grant for SL transmission of one or more/multiple TBs over multiple TOs, as described herein. The UE 802 may be configured to transmit/provide, and the SL UE 803 may be configured to receive, the one or more TBs 808 over a set of TOs in a CG period, as described herein (e.g., with respect to FIGS. 5-7).

In aspects for which SL HARQ feedback is enabled (e.g., when PSFCH resources are configured), the UE 802 may be configured to receive, and the SL UE 803 may be configured to transmit/provide, HARQ feedback 810 associated with the one or more TBs 808. The UE 802 may be configured to transmit/provide, and the base station 804 may be configured to receive, an indication 812 of the HARQ feedback associated with the one or more TBs 808. In some aspects, the SL UE 803 may be configured to transmit/provide the HARQ feedback 810 to the UE 802 over SL/PSFCH, and the UE 802 may be configured to transmit/provide the indication 812 of the HARQ feedback to the base station 804 in UL using the set of PUCCH resources 807 (e.g., based on/in accordance with the HARQ feedback 810 received from the SL UE 803 via SL). In some aspects, the set of PUCCH resources 807 may comprise or include a single PUCCH resource as configured for the UE 802 in the PSSCH configuration 806. In such aspects, the single PUCCH resource may be configured for the UE 802 per CG period. In one such example, a single bit (e.g., 1 bit) may be utilized for the HARQ feedback 810 (e.g., an aspect shown as HARQ feedback 810a) to be provided to the base station 804 via the set of PUCCH resources 807. Is such cases, the set of PUCCH resources may be a single PUCCH resource 807a for UL transmission of an indication 812a (e.g., an aspect of the indication 812). The one/single bit of the HARQ feedback 810a may indicate that the one or more TBs 808 are successfully delivered to the SL UE 803 over SL if all TBs of the one or more TBs 808 are successfully delivered to all SL Rx UE(s) for a CG period 816 (e.g., a NACK is not received over SL from Rx UEs). Otherwise, the HARQ feedback 810a may indicate unsuccessful delivery for the one or more TBs 808. In another such example, a number of bits (e.g., N bits) may be utilized for the HARQ feedback 810 (e.g., an aspect shown as HARQ feedback 810b) to be provided to the base station 804 via the set of PUCCH resources 807. Is such cases, the set of PUCCH resources may be a single PUCCH resource 807b for UL transmission of an indication 812b (e.g., an aspect of the indication 812). The number of bits N for the HARQ feedback 810b and in the single PUCCH resource 807b may be the same as the number of TBs in the one or more TBs 808 and/or the maximum number of TBs allowed in the CG period 816, and each bit of the N bits in the single PUCCH resource 807b may indicate whether the corresponding TB of the one or more TBs 808 is successfully delivered or not to SL Rx UE(s) (e.g., the SL UE 803). In aspects for single PUCCH resource utilization in HARQ feedback per CG period (e.g., the single PUCCH resource 807a/the single PUCCH resource 807b in the CG period 816), the single PUCCH resource may be later than a last configured PSSCH resource 814 in the CG period 816. In some aspects, the set of PUCCH resources 807 may be multiple PUCCH resources/a set of PUCCH resources 807c (e.g., N PUCCH resources) and may be configured to a SL Tx UE (e.g., the UE 802) per CG period (for the CG period 816) in the PSSCH configuration 806. The number N of PUCCH resources in the set of PUCCH resources 807c may be less than or equal to a number of TBs or a maximum number of TBs allowed for the CG period 816. In one such example, each PUCCH resource of the number N of the set of PUCCH resources 807c may be utilized by the UE 802 to transmit/provide HARQ feedback for the corresponding TB. That is, the UE 802 may be configured to transmit a respective indication of the HARQ feedback 810 (e.g., an indication 812c-1 to an indication 812c-N) for a TB of the one or more TBs 808 in a corresponding PUCCH resource of the set of PUCCH resources 807c (e.g., as a first PUCCH resource to an Nth PUCCH resource) prior to a next TB of the one or more TBs 808. As an example, the set of PUCCH resources 807c may be scattered within the CG period 816, such that a given PUCCH resource of the set of PUCCH resources 807c follows a corresponding last PSSCH resource 818 configured for each TB of the one or more TBs 808.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., sec UE 350 of FIG. 3) and include the additional modules of the apparatus 1104.

As discussed supra, the component 198 may be configured to identify a number of TBs to be transmitted, to a SL UE, during a period of a grant associated with a set of transmission occasions. The component 198 may be configured to receive, from a network node, a PSSCH configuration indicative of the grant associated with the set of transmission occasions for one or more TBs over a set of resources of the PSSCH during the period of the grant. The component 198 may be configured to transmit, via the PSSCH for the SL UE, the one or more TBs during the period of the grant in accordance with the PSSCH configuration. The component 198 may be configured to transmit, for the network node and prior to the reception of the PSSCH configuration, at least one of a capability of the UE or a configuration indication associated with transmissions of TBs, where the PSSCH configuration is associated with at least one of the capability of the UE or the configuration indication associated with the transmissions of TBs. The component 198 may be configured to receive, from the SL UE via a PSFCH, HARQ feedback associated with the one or more TBs. The component 198 may be configured to transmit, to the network node via the set of PUCCH resources, an indication of the HARQ feedback associated with the one or more TBs. The component 198 may be further configured to perform any of the aspects described in connection with the flowcharts in any of FIGS. 9, 10, and/or any of the aspects performed by a UE for any of FIGS. 4-8. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for identifying a number of TBs to be transmitted, to a SL UE, during a period of a grant associated with a set of transmission occasions. In one configuration, the apparatus 1104, and in particular the cellular baseband processor(s) 1124 and/or the application processor(s) 1106, may include means for receiving, from a network node, a PSSCH configuration indicative of the grant associated with the set of transmission occasions for one or more TBs over a set of resources of the PSSCH during the period of the grant. In one configuration, the apparatus 1104, and in particular the cellular baseband processor(s) 1124 and/or the application processor(s) 1106, may include means for transmitting, via the PSSCH for the SL UE, the one or more TBs during the period of the grant in accordance with the PSSCH configuration. In one configuration, the apparatus 1104, and in particular the cellular baseband processor(s) 1124 and/or the application processor(s) 1106, may include means for transmitting, for the network node and prior to the reception of the PSSCH configuration, at least one of a capability of the UE or a configuration indication associated with transmissions of TBs, where the PSSCH configuration is associated with at least one of the capability of the UE or the configuration indication associated with the transmissions of TBs. In one configuration, the apparatus 1104, and in particular the cellular baseband processor(s) 1124 and/or the application processor(s) 1106, may include means for receiving, from the SL UE via a PSFCH, HARQ feedback associated with the one or more TBs. In one configuration, the apparatus 1104, and in particular the cellular baseband processor(s) 1124 and/or the application processor(s) 1106, may include means for transmitting, to the network node via the set of PUCCH resources, an indication of the HARQ feedback associated with the one or more TBs. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

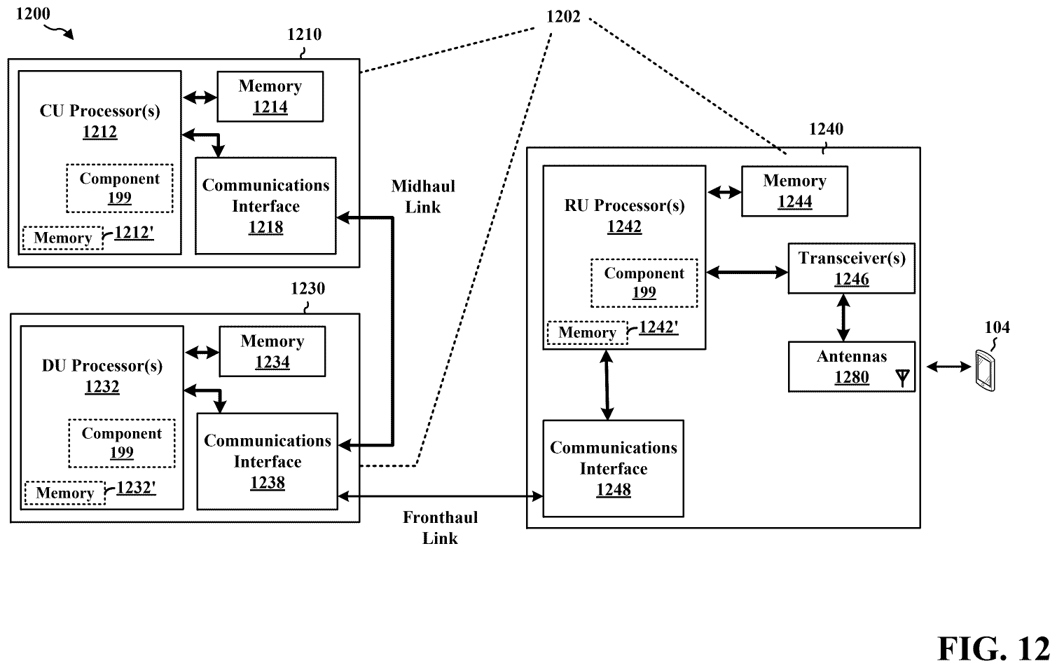

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a UE with a PSSCH configuration indicative of the grant associated with the set of transmission occasions for one or more TBs over a set of resources of the PSSCH during the period of the grant. The component 199 may be configured to receive, from the UE and prior to the reception of the PSSCH configuration, at least one of a capability of the UE or a configuration indication associated with transmissions of TBs, where the PSSCH configuration is associated with at least one of the capability of the UE or the configuration indication associated with the transmissions of TBs. The component 199 may be configured to receive, from the UE via the set of PUCCH resources, an indication of the HARQ feedback associated with the one or more TBs. The component 199 may be further configured to perform any of the aspects described in connection with the flowcharts in any of FIGS. 9, 10, and/or any of the aspects performed by a network entity/network node for any of FIGS. 4-8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for configuring a UE with a PSSCH configuration indicative of the grant associated with the set of transmission occasions for one or more TBs over a set of resources of the PSSCH during the period of the grant. In one configuration, the network entity 1202 may include means for receiving, from the UE and prior to the reception of the PSSCH configuration, at least one of a capability of the UE or a configuration indication associated with transmissions of TBs, where the PSSCH configuration is associated with at least one of the capability of the UE or the configuration indication associated with the transmissions of TBs. In one configuration, the network entity 1202 may include means for receiving, from the UE via the set of PUCCH resources, an indication of the HARQ feedback associated with the one or more TBs. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

A SL Tx UE may transmit signals to a SL receiver Rx UE via SL communications, such as for V2X communications. In V2X communications, communication capacity was not the main system design metric, given the relatively small payload, such as for basic safety applications utilizing a few hundred bytes for payloads being transmitted with a period greater than 100 ms. Even advanced NR V2X use cases (e.g., sensor sharing) do not utilize substantial payload capacity increases (e.g., approximately 10 times that of basic safety applications for V2X). Future use cases in V2X may utilize substantial capacity increases. One of the use cases may be sensor sharing, such as raw sensor data (e.g., live video frames, LIDAR images, etc.), which may be sent from vehicle to a cloud platform for processing. An option for such sharing is to send the sensor data to an RSU, as part of roadway infrastructure, which may send the collected sensor data to the network/cloud. Another use case may be for remote driving in which sensor data (e.g., a live video frame) may be sent from a vehicle to the cloud (e.g., to a remote driving control center) via an RSU in real time. In these use cases, a very large SL capacity may be needed (e.g., for a 1080 p video frame with 10-bit color depth and 1% compression). Another future use case may be for XR over SL in which video frames captured by XR on-board cameras may be sent to a UE, such as a smartphone, over SL communications for computation purposes. Mode 1 SL communications may be utilized in these new SL use cases where a network node/entity may allocate resources for SL transmissions, which may more suitable for high throughout traffic (e.g., as interference in Mode 2, or UE autonomous resource allocation, may significantly inhibit system performance). However, current solutions lack options for such high throughout traffic in SL communications. NR SL Mode 1 resource allocation may support CG implementations for reduced scheduling latency. For instance, with reference to CGs, a UE may send a message with UAI to a network node (e.g., a base station, a gNB, etc.) indicating characteristics about the expected SL traffic for the UE, and the network node may then configure a CG to the UE for transmission of the SL traffic. The CG may be configured using parameters such as a CG index, time-frequency resource allocation (e.g., for a slot(s) and a subchannel(s)), and a periodicity of the allocated resources, where the UE may be configured for a maximum of three SL resources in each CG period. The UE may decide how to use the SL resources of the assigned CG, but current solutions provide that the UE transmits a maximum of up to one new TB in each CG period, where resources configured by a CG can also be used for retransmission (e.g., of a new TB transmitted in the current or a previous CG period). A UE may be configured for multiple CGs, but transmission and retransmission of a given TB cannot use resources outside of those configured by a single CG (and on SL, a Tx UE configured with a CG may indicate the CG resource configuration using SCI-1). Sensor data transmission over SL, e.g., video frames, may utilize mostly large, yet varying, bandwidth between a SL Tx UE and SL Rx UE, and a very small over-the-air latency, and a CG PSSCH may be used for resource allocation for high-capacity traffic over SL with reduced scheduling latency. Yet, existing CG-PSSCH solutions do not allow for a meeting of the high-capacity SL transmissions noted herein. Thus, current solutions lack options for such high throughout traffic in SL communications.

Aspects herein for increased SL transmission capacity provide solutions to the issues noted above. Aspects enable high-capacity traffic over SL by utilizing CG PSSCH with multiple TOs for one or more/multiple TBs within a CG period. Aspects enable flexibility in resource selection and utilization by a SL Tx UE by utilizing resource options in a CG PSSCH with multiple TOs for one or more/multiple TBs within a CG period. Aspects also enable HARQ feedback for SL transmissions with multiple TOs for one or more/multiple TBs within a CG period by indicating PUCCH resources in a CG PSSCH with multiple TOs for one or more/multiple TBs within a CG period.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: identifying a number of transport blocks (TBs) to be transmitted, to a sidelink (SL) UE, during a period of a grant associated with a set of transmission occasions; receiving, from a network node, a physical sidelink shared channel (PSSCH) configuration indicative of the grant associated with the set of transmission occasions for one or more TBs over a set of resources of the PSSCH during the period of the grant; and transmitting, via the PSSCH for the SL UE, the one or more TBs during the period of the grant in accordance with the PSSCH configuration.

Aspect 2 is the method of aspect 1, wherein the PSSCH configuration is indicative of the set of resources in the period of the grant; wherein transmitting the one or more TBs during the period of the grant in accordance with the PSSCH configuration includes: selecting at least one resource of the set of resources for the transmission of the one or more TBs in accordance with the indicated set of resources.

Aspect 3 is the method of aspect 2, wherein the PSSCH configuration is indicative of at least one of a number of TBs or a maximum number of TBs for the period of the grant; wherein selecting the at least one resource of the set of resources for the transmission of the one or more TBs is further in accordance with at least one of the number of TBs or the maximum number of TBs.

Aspect 4 is the method of aspect 2, wherein selecting the at least one resource of the set of resources for the transmission of the one or more TBs in accordance with the indicated set of resources includes selecting a number of resources of the set of resources for transmitting each TB of the one or more TBs.

Aspect 5 is the method of any of aspects 1 to 4, wherein the PSSCH configuration is indicative of at least one respective resource of the set of resources in the period of the grant for each TB of the one or more TBs; wherein transmitting the one or more TBs during the period of the grant in accordance with the PSSCH configuration includes at least one of: selecting at least one resource of the set of resources for the transmission of the one or more TBs; or transmitting the one or more TBs during the period of the grant in accordance with the at least one respective resource of the set of resources in the period of the grant for each TB of the one or more TBs.

Aspect 6 is the method of aspect 5, wherein transmitting the one or more TBs during the period of the grant includes: transmitting, via SL control information (SCI) for the SL UE and in a current resource of the at least one respective resource of the set of resources, a resource indication of a subsequent one of the at least one respective resource for a TB of the one or more TBs associated with the current resource.

Aspect 7 is the method of aspect 6, wherein a first set of respective resources of the set of resources for a first TB of the one or more TBs is before a second set of respective resources of the set of resources for a second TB of the one or more TBs during the period of the grant.

Aspect 8 is the method of aspect 6, wherein transmitting, via the SCI for the SL UE and in the current resource of the at least one respective resource of the set of resources, the resource indication includes transmitting, via the SCI, a set of unique hybrid automatic repeat request (HARQ) process identifiers respectively associated with each of the one or more TBs.

Aspect 9 is the method of any of aspects 1 to 8, further comprising: transmitting, for the network node and prior to the reception of the PSSCH configuration, at least one of a capability of the UE or a configuration indication associated with transmissions of TBs, wherein the PSSCH configuration is associated with at least one of the capability of the UE or the configuration indication associated with the transmissions of TBs.

Aspect 10 is the method of aspect 9, wherein transmitting the configuration indication includes transmitting the configuration indication via at least one of a medium access control (MAC) control element (MAC-CE), a SL buffer status report (BSR), or UE assistance information (UAI); wherein the configuration indication includes at least one of a traffic type or a traffic characteristic associated with SL communications, wherein at least one of the traffic type or the traffic characteristic is indicative of transmissions for multiple transmission occasions for the one or more TBs, or wherein the configuration indication includes a request for the PSSCH configuration.

Aspect 11 is the method of aspect 9, wherein transmitting the capability of the UE includes transmitting the capability of the UE via at least one of a medium access control (MAC) control element (MAC-CE), a SL buffer status report (BSR), or UE assistance information (UAI); wherein the capability of the UE is indicative of UE support of transmissions for multiple transmission occasions for the one or more TBs.

Aspect 12 is the method of any of aspects 1 to 11, wherein the PSSCH configuration is further indicative of a set of physical uplink control channel (PUCCH) resources associated with the period of the grant; wherein the method further comprises: receiving, from the SL UE via a physical sidelink feedback channel (PSFCH), hybrid automatic repeat request (HARQ) feedback associated with the one or more TBs; and transmitting, to the network node via the set of PUCCH resources, an indication of the HARQ feedback associated with the one or more TBs.

Aspect 13 is the method of aspect 12, wherein the set of PUCCH resources includes a single PUCCH resource, wherein the indication of the HARQ feedback associated with the one or more TBs includes one bit that indicates a successful transmission of the one or more TBs or an unsuccessful transmission of at least one of the one or more TBs, wherein transmitting the indication of the HARQ feedback includes transmitting the indication of the HARQ feedback subsequent to a last resource of the set of resources of the PSSCH during the period of the grant.

Aspect 14 is the method of aspect 12, wherein the set of PUCCH resources includes a single PUCCH resource, wherein the indication of the HARQ feedback associated with the one or more TBs includes a set of bits that indicates a successful transmission or an unsuccessful transmission for a corresponding one of the one or more TBs, wherein the set of bits includes a number of bits equal to at least one of the number of TBs or a maximum number of TBs for the period of the grant, wherein transmitting the indication of the HARQ feedback includes transmitting the indication of the HARQ feedback subsequent to a last resource of the set of resources of the PSSCH during the period of the grant.

Aspect 15 is the method of aspect 12, wherein the set of PUCCH resources includes multiple PUCCH resources that are less than or equal to the number of TBs or a maximum number of TBs for the period of the grant, wherein transmitting the indication of the HARQ feedback includes transmitting a respective indication of the HARQ feedback for a TB of the one or more TBs in a corresponding PUCCH resource of the set of PUCCH resources prior to a next TB of the one or more TBs.

Aspect 16 is the method of any of aspects 1 to 15, wherein the one or more TBs are associated with extended reality (XR) video communications for an XR application.

Aspect 17 is an apparatus for wireless communication at a user equipment (UE), comprising: at least one memory; and at least one processor coupled to the at least one memory and, based at least in part on information stored in the at least one memory, the at least one processor, individually or in any combination, is configured to perform the method of any of aspects 1 to 16.

Aspect 18 is an apparatus for wireless communication at a user equipment (UE), comprising means for performing each step in the method of any of aspects 1 to 16.

Aspect 19 is the apparatus of any of aspects 17 and 18, further comprising a transceiver configured to receive or to transmit in association with the method of any of aspects 1 to 16.

Aspect 20 is a computer-readable medium (e.g., a non-transitory computer-readable medium) storing computer executable code at a user equipment (UE), the code when executed by at least one processor causes the at least one processor to perform the method of any of aspects 1 to 16.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
identify a number of transport blocks (TBs) to be transmitted, to a sidelink (SL) UE, during a period of a grant associated with a set of transmission occasions;
receive, from a network node, a physical sidelink shared channel (PSSCH) configuration indicative of the grant associated with the set of transmission occasions for one or more TBs over a set of resources of the PSSCH during the period of the grant; and
transmit, via the PSSCH for the SL UE, the one or more TBs during the period of the grant in accordance with the PSSCH configuration.

2. The apparatus of claim 1, wherein the PSSCH configuration is indicative of the set of resources in the period of the grant;
wherein to transmit the one or more TBs during the period of the grant in accordance with the PSSCH configuration, the at least one processor, individually or in any combination, is configured to:
select at least one resource of the set of resources for the transmission of the one or more TBs in accordance with the indicated set of resources.

3. The apparatus of claim 2, wherein the PSSCH configuration is indicative of at least one of the number of TBs or a maximum number of TBs for the period of the grant;
wherein to select the at least one resource of the set of resources for the transmission of the one or more TBs, the at least one processor, individually or in any combination, is configured to select the at least one resource of the set of resources further in accordance with at least one of the number of TBs or the maximum number of TBs.

4. The apparatus of claim 2, wherein to select the at least one resource of the set of resources for the transmission of the one or more TBs in accordance with the indicated set of resources, the at least one processor, individually or in any combination, is configured to select a number of resources of the set of resources for a transmission of each TB of the one or more TBs.

5. The apparatus of claim 1, wherein the PSSCH configuration is indicative of at least one respective resource of the set of resources in the period of the grant for each TB of the one or more TBs;
wherein to transmit the one or more TBs during the period of the grant in accordance with the PSSCH configuration, the at least one processor, individually or in any combination, is configured to at least one of:
select at least one resource of the set of resources for the transmission of the one or more TBs; or
transmit the one or more TBs during the period of the grant in accordance with the at least one respective resource of the set of resources in the period of the grant for each TB of the one or more TBs.

6. The apparatus of claim 5, wherein to transmit the one or more TBs during the period of the grant, the at least one processor, individually or in any combination, is configured to:
transmit, via SL control information (SCI) for the SL UE and in a current resource of the at least one respective resource of the set of resources, a resource indication of a subsequent one of the at least one respective resource for a TB of the one or more TBs associated with the current resource.

7. The apparatus of claim 6, wherein a first set of respective resources of the set of resources for a first TB of the one or more TBs is before a second set of respective resources of the set of resources for a second TB of the one or more TBs during the period of the grant.

8. The apparatus of claim 6, wherein to transmit, via the SCI for the SL UE and in the current resource of the at least one respective resource of the set of resources, the resource indication, the at least one processor, individually or in any combination, is configured to transmit, via the SCI, a set of unique hybrid automatic repeat request (HARQ) process identifiers respectively associated with each of the one or more TBs.

9. The apparatus of claim 1, wherein the at least one processor, individually or in any combination, is further configured to:
transmit, for the network node and prior to the reception of the PSSCH configuration, at least one of a capability of the UE or a configuration indication associated with transmissions of TBs, wherein the PSSCH configuration is associated with at least one of the capability of the UE or the configuration indication associated with the transmissions of TBs.

10. The apparatus of claim 9, wherein to transmit the configuration indication, the at least one processor, individually or in any combination, is configured to transmit the configuration indication via at least one of a medium access control (MAC) control element (MAC-CE), a SL buffer status report (BSR), or UE assistance information (UAI);
wherein the configuration indication includes at least one of a traffic type or a traffic characteristic associated with SL communications, wherein at least one of the traffic type or the traffic characteristic is indicative of transmissions for multiple transmission occasions for the one or more TBs, or
wherein the configuration indication includes a request for the PSSCH configuration.

11. The apparatus of claim 9, wherein to transmit the capability of the UE, the at least one processor, individually or in any combination, is configured to transmit the capability of the UE via at least one of a radio resource control (RRC) message, a medium access control (MAC) control element (MAC-CE), a SL buffer status report (BSR), or UE assistance information (UAI);
wherein the capability of the UE is indicative of UE support of transmissions for multiple transmission occasions for the one or more TBs.

12. The apparatus of claim 1, wherein the apparatus further comprises at least one transceiver coupled to the at least one processor, wherein the PSSCH configuration is further indicative of a set of physical uplink control channel (PUCCH) resources associated with the period of the grant;
wherein the at least one processor, individually or in any combination, is further configured to:
receive, from the SL UE via a physical sidelink feedback channel (PSFCH), hybrid automatic repeat request (HARQ) feedback associated with the one or more TBs; and
transmit, to the network node via the set of PUCCH resources and the at least one transceiver, an indication of the HARQ feedback associated with the one or more TBs.

13. The apparatus of claim 12, wherein the set of PUCCH resources includes a single PUCCH resource, wherein the indication of the HARQ feedback associated with the one or more TBs includes one bit that indicates a successful transmission of the one or more TBs or an unsuccessful transmission of at least one of the one or more TBs, wherein to transmit the indication of the HARQ feedback, the at least one processor, individually or in any combination, is further configured to transmit the indication of the HARQ feedback subsequent to a last resource of the set of resources of the PSSCH during the period of the grant.

14. The apparatus of claim 12, wherein the set of PUCCH resources includes a single PUCCH resource, wherein the indication of the HARQ feedback associated with the one or more TBs includes a set of bits that indicates a successful transmission or an unsuccessful transmission for a corresponding one of the one or more TBs, wherein the set of bits includes a number of bits equal to at least one of the number of TBs or a maximum number of TBs for the period of the grant, wherein to transmit the indication of the HARQ feedback, the at least one processor, individually or in any combination, is further configured to transmit the indication of the HARQ feedback subsequent to a last resource of the set of resources of the PSSCH during the period of the grant.

15. The apparatus of claim 12, wherein the set of PUCCH resources includes multiple PUCCH resources that are less than or equal to the number of TBs or a maximum number of TBs for the period of the grant, wherein to transmit the indication of the HARQ feedback, the at least one processor, individually or in any combination, is further configured to transmit a respective indication of the HARQ feedback for a TB of the one or more TBs in a corresponding PUCCH resource of the set of PUCCH resources prior to a next TB of the one or more TBs.

16. The apparatus of claim 1, wherein the one or more TBs are associated with extended reality (XR) video communications for an XR application.

17. A method of wireless communication at a user equipment (UE), comprising:
identifying a number of transport blocks (TBs) to be transmitted, to a sidelink (SL) UE, during a period of a grant associated with a set of transmission occasions;
receiving, from a network node, a physical sidelink shared channel (PSSCH) configuration indicative of the grant associated with the set of transmission occasions for one or more TBs over a set of resources of the PSSCH during the period of the grant; and
transmitting, via the PSSCH for the SL UE, the one or more TBs during the period of the grant in accordance with the PSSCH configuration.

18. The method of claim 17, wherein the PSSCH configuration is indicative of the set of resources in the period of the grant;
wherein transmitting the one or more TBs during the period of the grant in accordance with the PSSCH configuration includes:
selecting at least one resource of the set of resources for the transmission of the one or more TBs.

19. The method of claim 17, further comprising:
transmitting, for the network node and prior to the reception of the PSSCH configuration, at least one of a capability of the UE or a configuration indication associated with transmissions of TBs, wherein the PSSCH configuration is associated with at least one of the capability of the UE or the configuration indication associated with the transmissions of TBs.

20. A computer-readable medium storing computer executable code at a user equipment (UE), the code when executed by at least one processor causes the at least one processor to:
identify a number of transport blocks (TBs) to be transmitted, to a sidelink (SL) UE, during a period of a grant associated with a set of transmission occasions;
receive, from a network node, a physical sidelink shared channel (PSSCH) configuration indicative of the grant associated with the set of transmission occasions for one or more TBs over a set of resources of the PSSCH during the period of the grant; and
transmit, via the PSSCH for the SL UE, the one or more TBs during the period of the grant in accordance with the PSSCH configuration.
